(19) United States
(12) Patent Application Publication
(10) Pub. No.: US 2009/0265390 A1
(43) Pub. Date: Oct. 22, 2009

(54) EVENT MANAGEMENT SYSTEM, EVENT MANAGEMENT METHOD AND EVENT MANAGEMENT PROGRAM

(76) Inventor: Katsuhide Asanuma, Fujiyoshida-shi (JP)

Correspondence Address: MCNEELY BODENDORF LLP, P.O. BOX 34175, WASHINGTON, DC, 20043, US

(21) Appl. No.: 12/207,475

(22) Filed: Sep. 9, 2008

(30) Foreign Application Priority Data
Sep. 18, 2007 (JP) 2007-240485
Dec. 25, 2007 (JP) 2007-332151
Jul. 16, 2008 (JP) 2008-184502

(51) Int. Cl. G06Q 10/00; G06F 17/30

(52) U.S. Cl. 707/200; 705/8; 707/E17.044; 715/234

(57) ABSTRACT

An event management system for executing the management regarding the event that includes an event plan making means for constructing the event plan or an event plan component by a structured document and making an feasible event plan by means of combination thereof and an event execution means for executing transmission of a message and reception of a response between entry terminals used by event entries to control progress of the event.

### CROSS REFERENCE TO RELATED APPLICATIONS

This application claims priority to the following: Japanese patent application No. 2007-240485 filed on Sep. 18, 2007; Japanese patent application No. 2007-332151 filed on Dec. 25, 2007; and Japanese patent application No. 2008-184502 filed on Jul. 16, 2008; which are incorporated by reference herein.

### FIELD OF THE INVENTION

The present invention relates to an event management system, an event management method and an event management program connected to terminals of entries used by the entries of the event and terminals at the side of an organizer via communication network.

### BACKGROUND OF THE INVENTION

In the case of running an event, manifold information processing is necessary to execute preparation of the event, management of schedule, reception of entries, entrance management, accounting process and the like. Conventionally, an event management system is proposed to manage the event.

As the most well-known system, electronic issue system is widely utilized to apply to entrance to the event or pay an entrance fee and the like via the network. Especially, the system shifts from dedicated on-line system used by a past ticket agent to system via internet common people can use corresponding to spread of the internet.

In the publication of unexamined patent application JP2005-165904, an event management system is disclosed to pass mobile terminals to entries at the exhibition and the like to transmit information prepared beforehand or information modified emergently to the associated mobile terminals.

The system comprises plural mobile terminals having the same function to be lent to the entries who engage in the event, a transmitted information management terminal of the event bureau which register identification codes of the mobile terminals and individual information transmitted to the mobile terminals in the host computer and administer them, and an information transmitting server to transmit the individual information registered in the host computer to the mobile terminals.

The transmitting server transmits the identification codes and the individual information of the mobile terminals entered by the transmitted information management terminal to the mobile terminals and then the mobile terminals can display the received individual information on the display part or can output it by means of sound.

In the publication of unexamined patent application JP2003-76818, an activity management apparatus is proposed to estimate or retrieve useful information from positional information to administer the personal activity to participate the event by means of GPS mounted on mobile phone or PDA.

The apparatus comprises a positional information acquisition means to capture the positional information every predetermined hours, a memory means to memorize the positional information captured from the GPS, an activity management information estimate and retrieval means to estimate or retrieve information to execute activity management from the positional information every predetermined hours memorized in the memory means, and an activity list making means to make an activity list based on the estimated or retrieved information.

However, at the above-mentioned prior event management system, the following problems have happened.
(1) Problem of Every Event

It is difficult to pattern since the entries, facilities, and time zone can be different at the every event unlike the normal routine work. In addition, it is necessary to consider the method to capture events which dependency on the facilities is high and frequency is low in the system in order to enhance the generality of the system and broaden coverage of the system since the dependency on the facilities or repetitive times and the like disperse depending on the nature of each event.

In many cases, the value of the event exists on the different content of the event even though the event is repeated. The different event is necessary for an individual entry on every event since the power to collect entries to manneristic event decrease rapidly.
(2) Problem of Importance of Plan

How to provide services is very important since the purpose of the event is to provide amazement and interest to the entries except for a part of services to use the work. The ability to devise and lay out the plan needs a sense of interest or group mind to human enjoyment and it is different from the skill about system structure. At this point, it is necessary to consider to share a role with a maker of plan application to structure the system.

In addition, it is necessary to make many plans and consume them in the case of providing services regarding the events because of the above problem of every event.
(3) Problem of Event Entry

The entrance into the services is almost limited from the control screen in the internet services. However, the entry from the screen is important one, but not only one, for the event services which have to move the body to receive the service.

The entry from a signboard or a display on the street, a service spot or a terminal at the storefront, or event place itself is necessary. Therefore, it is very difficult to absorb cost for structuring these interface into one for an individual service.
(4) Problem of Management of Entry Information

At the present, virtual character information which should be called second character is forming on the internet. It become common to have a identity in response to characteristic of media, such as an individual information like avatar etc. on the communication site, character information of on-line game and the like.

It was common to differentiate plural characters by means of context at the initiation and the like by flourish of secret society in the past American society or religious honor and the like. It is necessary to capture such laical entry information and custom information of a company in order to enhance appeal power of the event management system and promote the spread, but it is very difficult to realize these by means of the individual service.
(5) Problem of Information Provision Form

It is impossible to presume watch on the screen unlike service provision by PC, in the case of providing the event management service. In addition, it is presumed that time range or area of the individual event service is very various. In this case, it is unreasonable that one particular service always occupies interface or a part of function of the terminal equipments.

The only processing corresponding to the present context in the services provided should be called to the terminal and the other services stand by at the server and the like to transmit the necessary message. The upper system is required to administer an individual service to do so.

In order to overcome the above problems, the object of the present invention is to provide an event management system, an event management method and an event management program to be able to structure common event management system as SP (a service provider) to provide function to make plan application to an organizer of the event, and execute the operation and accounting process.

### SUMMARY OF THE INVENTION

In order to achieve the above objects, the present invention is an event management system for executing the management regarding the event comprising: an event plan making means for constructing the event plan or an event plan component by a structured document and making an feasible event plan by means of combination thereof; and an event execution means for executing transmission of a message and reception of a response between entry terminals used by event entries to control progress of the event.

The event management system may further comprise a log open means for acquiring log information of the entry while the event execution means control the progress of the event and making reference to information provided by a organizer or the log information of the entry mutually based on the document of the common event plan component executing the management at the time of event execution by the entry or node identification information.

The event management system may further comprise a means for recording the event plan and the event plan component in a database to be able to open and refer, and a step for discriminating the difference of the structured document between the event plan referred by a event plan maker and the event plan made by the event plan making means to execute copyright process to the entries if there is similarity between them.

The present invention is an event management method for executing the management regarding the event comprising: an event plan making step for constructing the event plan or an event plan component by a structured document and making an feasible event plan by means of combination thereof; and an event execution step for executing transmission of a message and reception of a response between entry terminals used by event entries to control progress of the event.

The event management method may further comprise a log open step for acquiring log information of the entry while the event execution means control the progress of the event and opening it.

The event management method may further comprise a step for discriminating the difference of the structured document between the event plan referred by entries and the event plan made by the event plan making means to charge the entries with the costs if there is similarity between them.

In addition, the present invention is a computer-readable event management program for allowing the computer to perform the above mentioned each step.

According to the present invention, it is possible to manage the event efficiently and properly.

### BRIEF DESCRIPTION OF THE DRAWINGS

FIG. 1 is a block diagram showing components of an event management system according to the present invention;

FIG. 2 is a block diagram showing transition of state of an event plan of an event management system according to the present invention;

FIG. 3 is a flowchart showing a flow for making an event plan of an event management system according to the present invention;

FIG. 4 is a flowchart showing a flow for recording API of an event management system according to the present invention;

FIG. 5 is a flowchart showing transition of condition of an event log of an event management system according to the present invention;

FIG. 6 is a flowchart showing a flow for using a log of an event management system according to the present invention;

FIG. 7a is a flowchart showing a flow for acquiring a log of an event management system according to the present invention;

FIG. 7b is a flowchart showing a flow for acquiring a log of an event management system according to the present invention;

FIG. 8a is a flowchart showing a flow for extracting information related to an event management system according to the present invention;

FIG. 8b is a flowchart showing a flow for extracting information related to an event management system according to the present invention;

FIG. 8c is a flowchart showing a flow for extracting information related to an event management system according to the present invention;

FIG. 9a is a flowchart showing a flow for html conversion of an event management system according to the present invention;

FIG. 9b is a flowchart showing a flow for html conversion of an event management system according to the present invention;

FIG. 9c is a flowchart showing a flow for html conversion of an event management system according to the present invention;

FIG. 10a is a flowchart showing a flow for making a slide view of an event management system according to the present invention;

FIG. 10b is a flowchart showing a flow for making a slide view of an event management system according to the present invention;

FIG. 11 is a flowchart showing a flow for making a related list of an event management system according to the present invention;

FIG. 12 is a block diagram showing a transition control of a scene and a cut of an event management system according to the present invention;

FIG. 13 is a block diagram showing a member scene control of an event management system according to the present invention;

FIG. 14 is a block diagram showing a member response control of an event management system according to the present invention;

FIG. 15 is a block diagram showing components of a message of an event management system according to the present invention;

FIG. 16 is a block diagram showing liaison with service function of an event management system according to the present invention;

FIG. 17 is a block diagram showing logging at the time of executing an event management system according to the present invention;

FIG. 18 is a block diagram showing a scene exceptive monitoring control of an event management system according to the present invention;

FIG. 19 is a flowchart showing an entire flow of an event management system according to the present invention;

FIG. 20 is a flowchart showing a preprocess of an event management system according to the present invention;

FIG. 21 is a flowchart showing a plan execution process of an event management system according to the present invention;

FIG. 22 is a flowchart showing a log open process of an event management system according to the present invention;

FIG. 23 is a block diagram showing a logic model for checking accounting of an event management system according to the present invention;

FIG. 24 is a diagram showing a scene transition definition of an event management system according to the present invention in an indented text form;

FIG. 25 is a diagram showing a scene transition definition of an event management system according to the present invention in a XML form;

FIG. 26 is a diagram showing a difference between process sorts in scenes of an event management system according to the present invention;

FIG. 27 is a diagram showing a scene status que table of an event management system according to the present invention;

FIG. 28 is a diagram showing an example of transition information at XML description of an event management system according to the present invention;

FIG. 29 is a flowchart showing a scene transition process of an event management system according to the present invention;

FIG. 30 is a diagram showing an integration model of an event management system according to the present invention;

FIG. 31 is a flowchart showing an action at the time of manifest of an event management system according to the present invention;

FIG. 32 is a block diagram showing a definition of a category of an event management system according to the present invention; and

FIG. 33 is a block diagram showing a characteristic of specification related to integration of resource condition of an event plan component of an event management system according to the present invention.

### DETAILED DESCRIPTION

We will now describe an embodiment of the present invention with reference to the accompanying drawings.

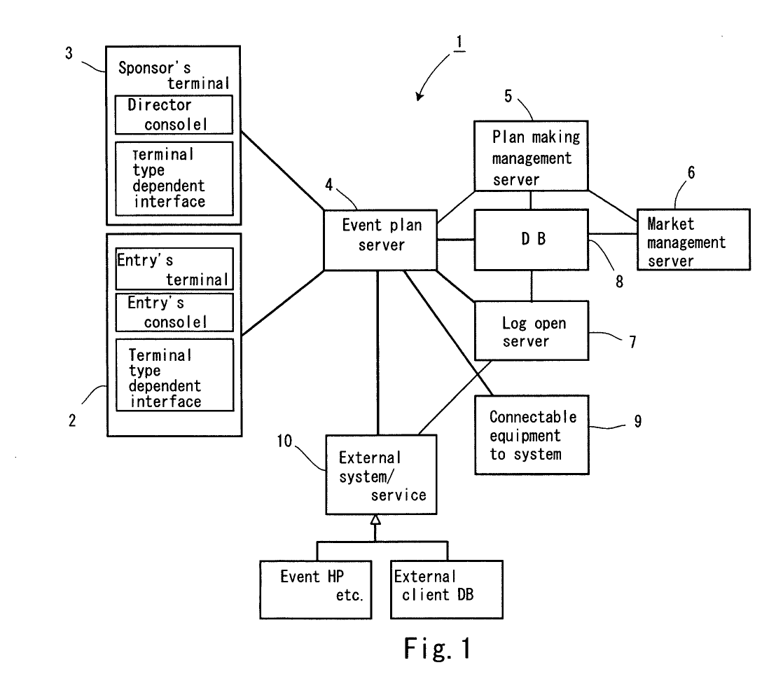

As shown on the FIG. 1, an event management system according to one of the embodiments of the present invention comprises entries' terminals 2 used by entries, organizers' terminals 3 used by organizers, a plan execution server 4 administered by system administrator, a plan making management server 5, a market management server 6, a log open server 7, a database 8, a resource 9 administered by a resource provider, and an exterior system 10.

The resource called herein includes an audiovisual equipment, a game equipment, a charge system terminal, and an apparatus having API for interface to be able to control by an event management plan in articles and the like which include an identification management means such as a QR code, an IC tip and a radio and the like.

This event management system is constructed by combining event plans registered on the market properly or utilizing a structured language to make a feasible event plan by adapting to a resource scene at the time of executing the plan and import information to manage the plan execution to execute re-registration of the event plan and export of the event data. The main two functions of the event execution management are to execute transmission of the message and receipt of the response between the entries' terminals and the venue terminals to control the event progress, and to execute call and control to an optimal terminal and a resource at the optimal time of the related application which becomes attraction and utility of the event.
(A) Independence of the Event Plan and Structuralization of the Documents

The first feature of the present invention is independence of the event plan. The independence of this event plan comprises constitution to register a recyclable event plan which abstracts context information to the market to read the feasible event plan added a resource such as a concrete facility and the manifest information such as date to it to execute.

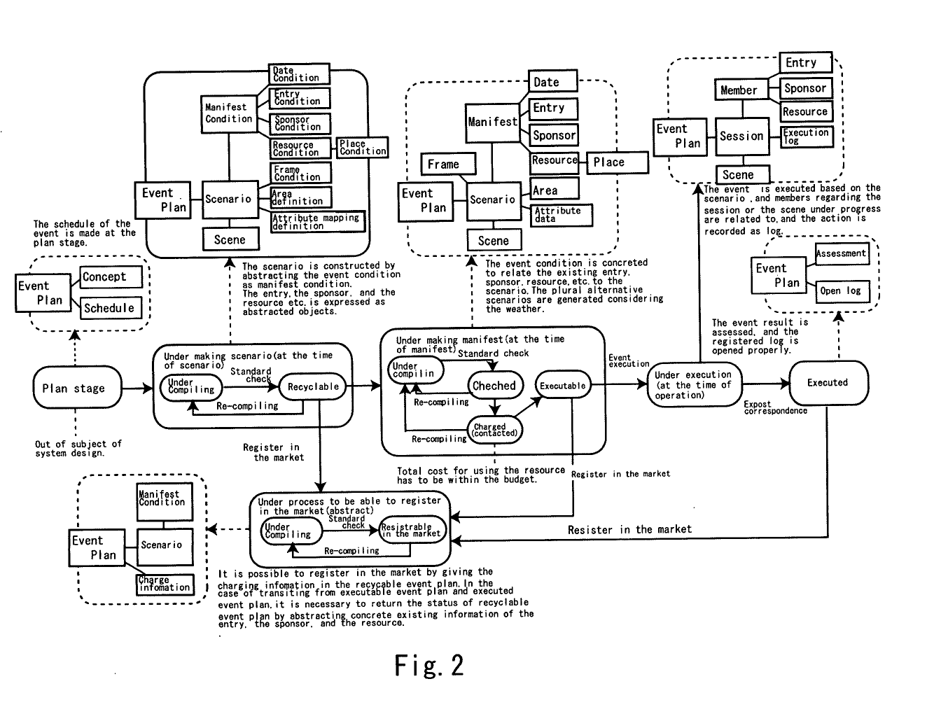

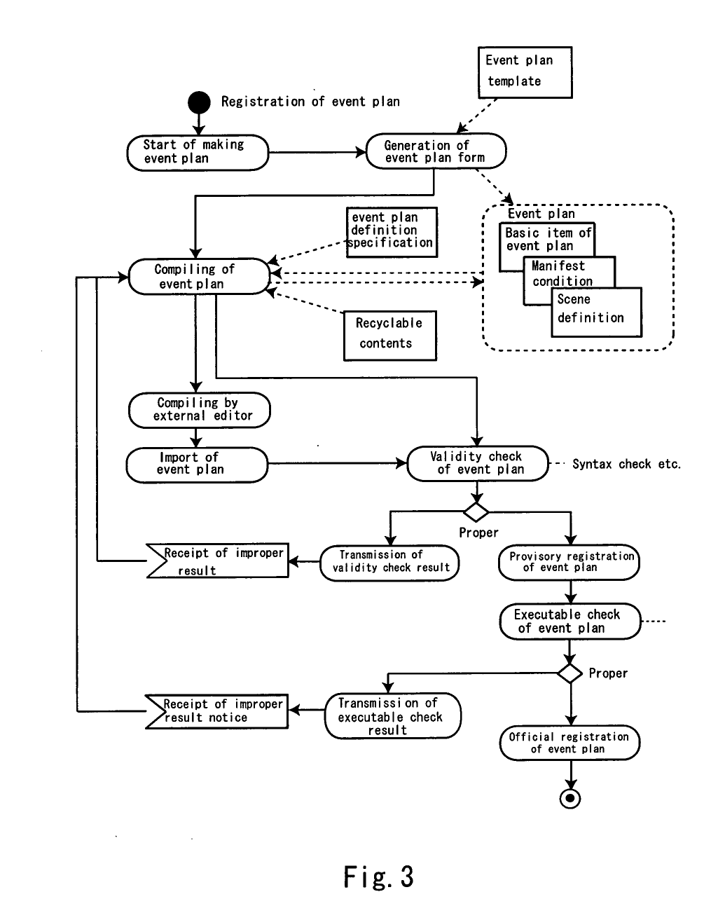

The FIG. 2 shows transition of state of the event plan and the FIG. 3 is a flowchart showing a flow to make the event plan. In the market a scenario described the structure of the event plan and a resource information such as a facility and the like which are content of the manifest are categorized to be registered separately. Thus it is possible to enhance recycling degree of the event plan. This is efficient since a resale market of a plan comes into existence as the same plan is of value in the case that once event plan are executed at another context.

The second feature of the present invention is structuralization of the documents of the event plan. The information skill level of the event planner is various. Considering that spread of the internet result from not only advantage of system but also development of www which adopts html language, it is useful to spread the event management system to use the structured language which is easier that the described language and similar to html language to make the event plan.

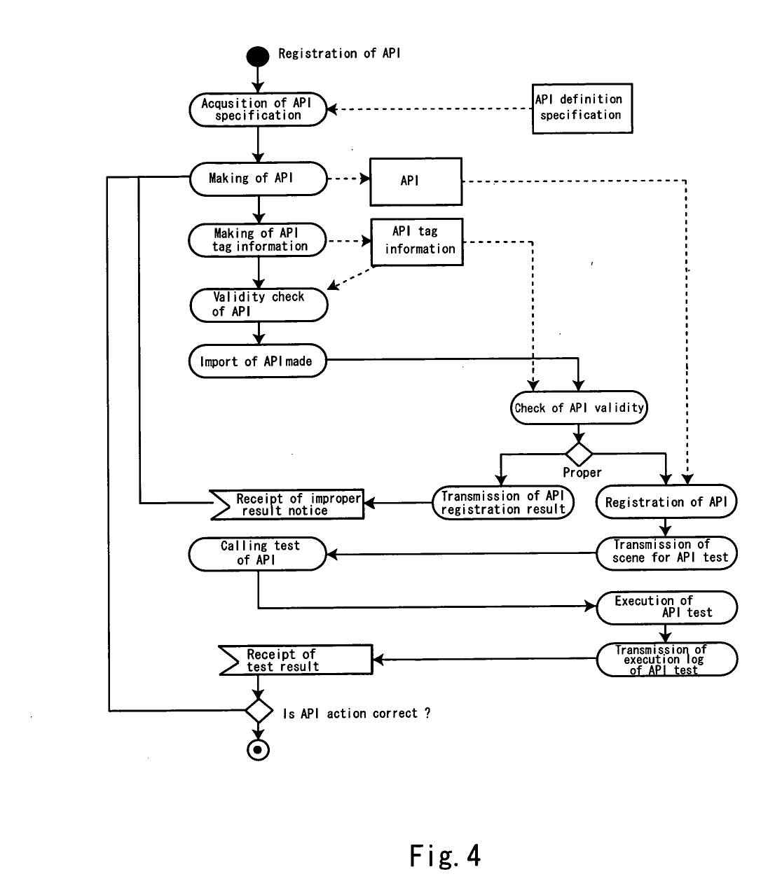

By limiting the description of the event plan as the above, the planner can execute natural separation of layer between control whose level is difficult to structure language to concentrate entire constitution, content of the message and timing of transmission, and selection of a service to be called. In one of the present embodiments, it is called integration of control whose level is difficult to structure language as API (Application Program Interface). The APL is registered by the flow shown on the FIG. 4.

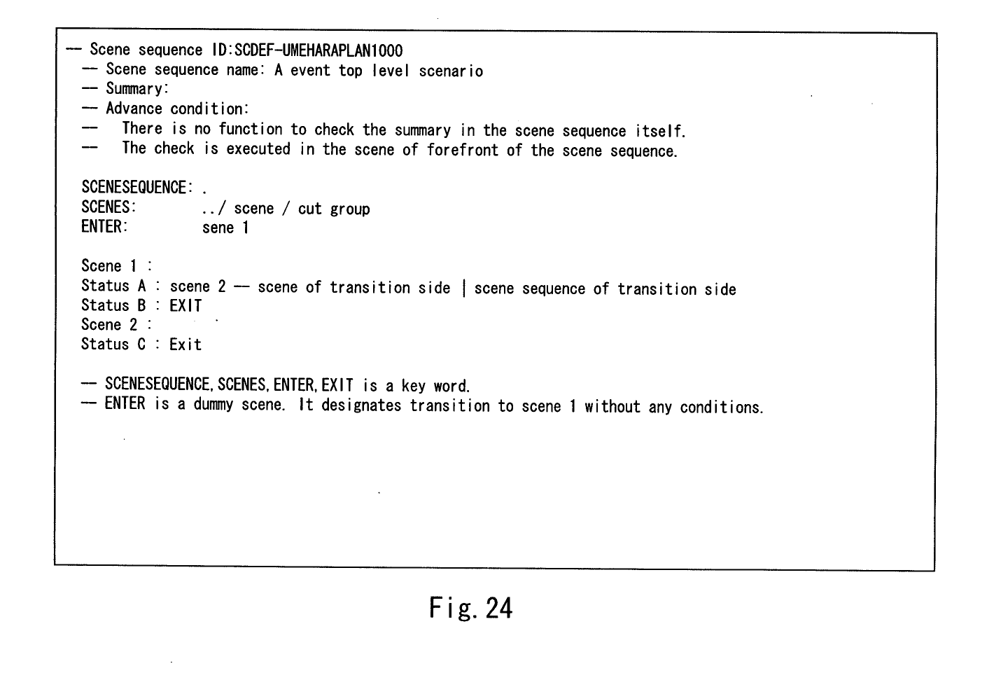

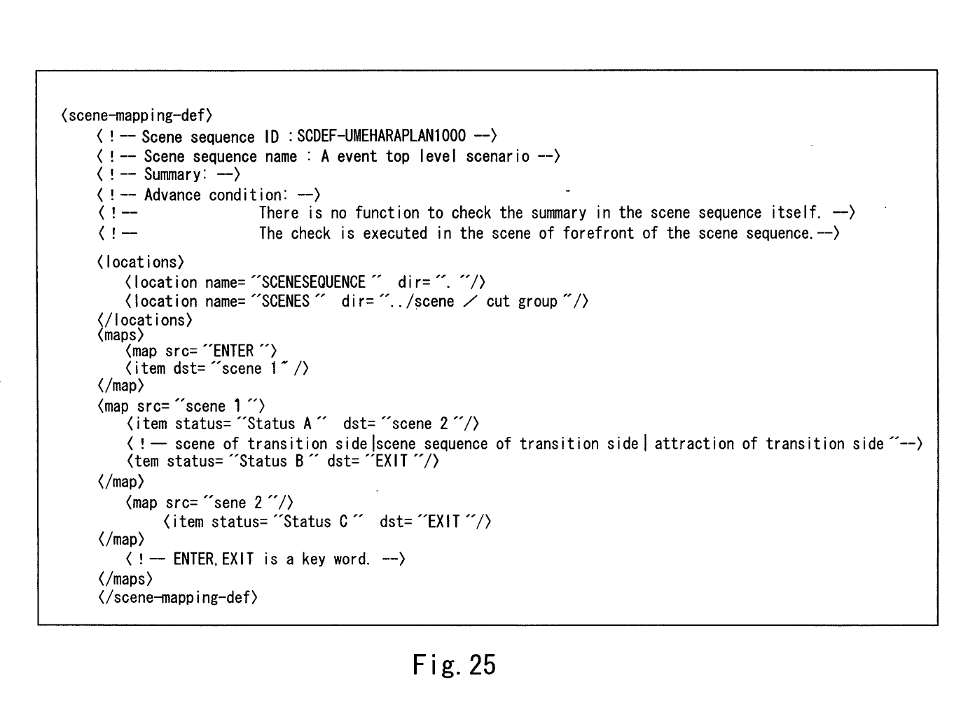

Alternatively, these registrations include structure information, transition information and element information to be able to convert by means of easy interpretation involving sequential or significant interpretation in the structured language. It may be registered in the indented text form as shown on the FIG. 24 or in the XML form as shown on the FIG. 25.

This API is a low level component to be available properly. It includes low level function provided by the present system (calling cut or performance, output of log, and standard transmission and the like) and function for access to a variety of resources and the like. The attraction and performance are not classified herein since they are described at the scene and cut. The API can be used from inside of the description of the scene and cut, and inside of the service component. The service component can be included in the API, and it is higher level one which is condensed by recognizing the event domain and the scene to be used.

In addition, the service component includes inducement, guidance, rarity management, group management, and a various service components provided by vendor and the like, besides a group communication component. Generally, the attraction is realized by combination of various services, but it can be an independent service component.

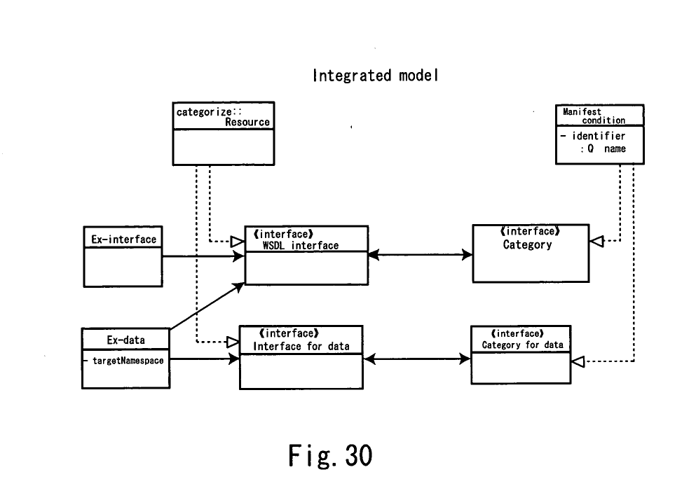

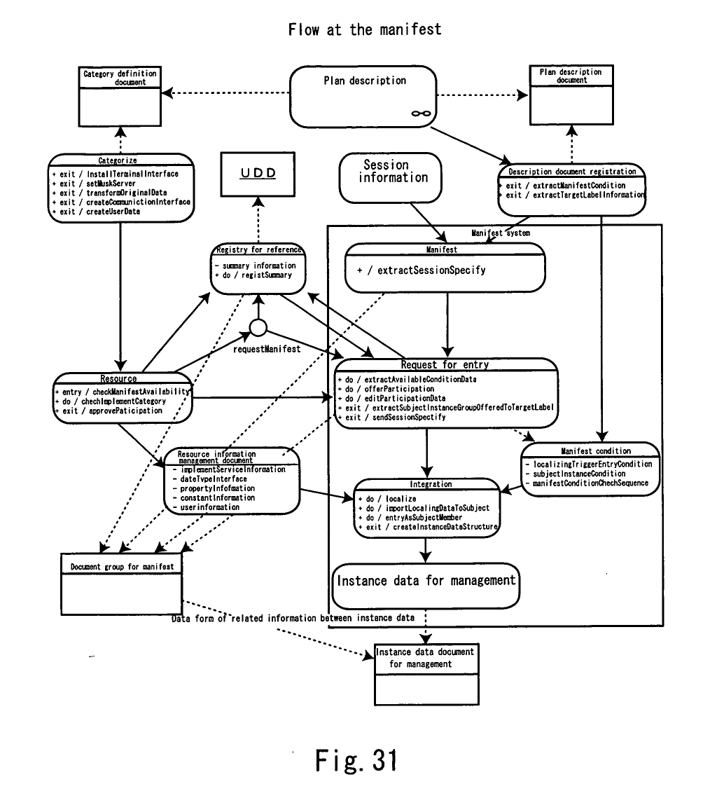

As shown on the FIGS. 30 and 31, the event plan document has document description specification consisting of more than three levels of event plan documents in order to realize the above structured language. The first level is an event plan description document which describes relation for executing control between scene management node and of integrated resources and of entry's equipment, and motion of each element. The second level is a manifest resource condition definition which defines specification information for equipping interface to be able to manifest to an individual resource and a entry equipment. The third level is a resource information management document for manifest to be generated as a result of applying the second document to an individual resource. The manifest management document has interface information of the individual resource and entry's equipment, category information, attribute information such as place and available time and the like, related information between the resource and the entry's equipment such as property information or reference or attribute value and the like. Furthermore, it includes data type of reference information which describes detail information.

The service component applied information in the plan description document has category information of a resource to be able to integrate, identification name or code for manifest is put on each of them. These identifiers are extracted and integrated on every plan document and condition of manifest is generated at the time of manifest. As a result, category of the necessary resource and number of the resource for execution of the event on every identifier are verified as a demand resource condition. The conditions of place and time are ones of place and time of the event plan part to be integrated finally.

The category definition document includes interface definition information to be able to realize motion of the resource that contact side and plan side demand. This demand may include specification to register resource summary information for manifest besides realization of motion at the time of session in registry for reference such as UDDI and the like, specification to renew the summary information according to demand of the system side, specification to return entry possible information, and specification to receive and register manifest condition to integrate itself. This form may be one to demand high level function such as definition of port type of WSDL and the like. Furthermore, an application that generates the third document according to the category information may be attached to.

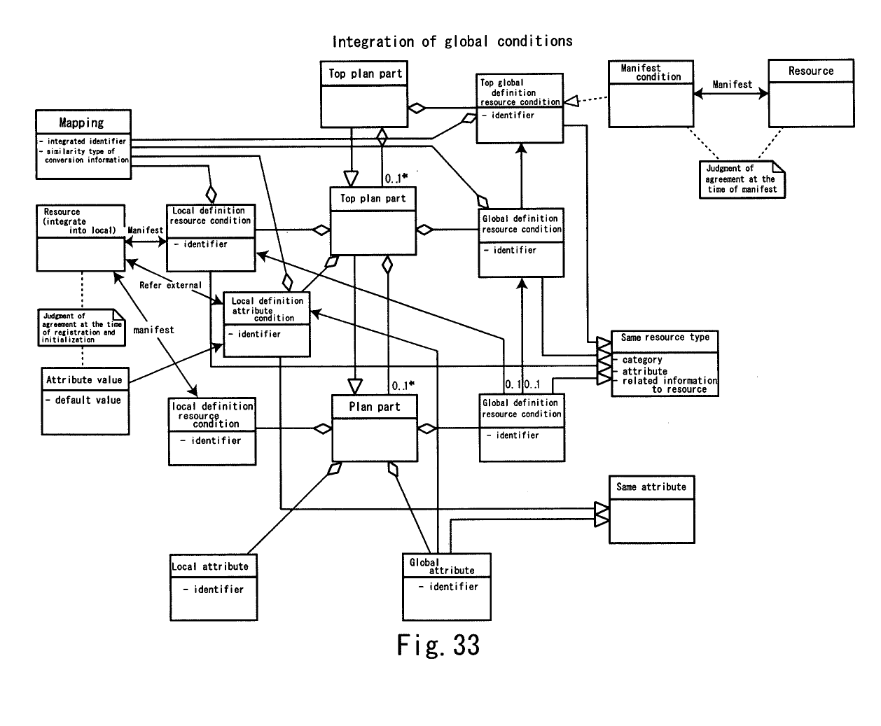

Next, we will describe features about specification related to integration of the resource condition of the event plan part with reference to the FIG. 33 mainly.

The resource condition is applied to the resource information selected to match at the time of receipt, but it is necessary to integrate the resource condition information of the inside plan part and scope information of attribute.

Accordingly, the present system layers the plan part to integrate as element of the top document. The attribute of each plan part or definition information of the resource are defined as local definition or global definition on every part. The upper plan part has to leave definition of integrated lower part to the definition of upper part as the global definition, or describe as the local definition at the layer. Finally, the element of the global definition becomes manifest condition and subject to be applied at the definition of the upper plan part.

The resource information defined herein includes category information on the market, important status transition information and it refers to the status transition relation of the plan part as the after-mentioned demand resource information to order to be integrated as demand resource of the upper plan part.

The local definition of the resource means to provide part in the form of adaptation to detail resource at the stage of making the plan part to the market. The resource of the local definition is impossible to select a resource, and detail resource ID is described on the definition information.

The definition of attribute depends on which stage the attribute value is held. The attribute value of the global definition is held on any upper layer. It is necessary to describe definition of the attribute information of the lower layer of the global definition locally or rise to the upper layer. Furthermore, it is possible to describe the same attribute type or the each attribute type to be able to convert by mapping to re-define the each attribute defined globally at the plural lower layer as global attribute at the one or under one layer. The deal of attribute information defined globally at the top is decided at the time of manifest.

Namely, an analysis apparatus to read the attribute definition information, or the lower attribute information or the mapping information hold the definition information to refer the upper mapping and scope definition description to hold information to be added in the list when global definition was done at the time of execution. It secures attribute type area re-defined in the sequence object of the layer, and holding area of the reference information at mapping area.

The deal of the initial attribute value is also decided at the time of the local definition. The definition of the default value or the execution of the exterior reference is selected.

As the FIG. 31, the action of the plan management system and each document at the time of manifest is as follows.

At first, manifest system the plan description document is registered become waiting condition for registration of session information. The manifest begins when the session information related to name of a plan registration document registered at this time is entered. The session information includes the event opening time information, place information of the event plan part which becomes manifest condition.

The manifest condition is integrated and validated when the manifest begins. The integration of the resource number according to the related application is validated and the grammar is validated according to the specification at the time of the integration. Furthermore, dependency relation between the definitions is validated. The manifest conditions which are related information between the resources such as property, reference or attribute value, or attribute value gained from result function used as an argument are extracted. As a result, it is checked by the resource which is independent of the other manifest conditions and the entry's manifest condition, and items which depend on other manifest conditions are validated on whether it depends on the only manifest condition already checked, it is validated if so. This is repeated and the check sequence of the manifest condition lined up conditions checked beforehand is generated. It will be exception of the grammar if the co-independent relationship exists.

Furthermore, priority relationship on the calculation may be set on dependent relationship in order to mitigate limitation on this co-independent relationship. In this case, the check sequence is made on every level of the priority ranking. The exception will not occur if the co-independence does not occur in the level of co-independent relationship at the initial grammatical check.

Then, further entry request begins. The summary information to match with the manifest condition which does not depend on the other resources is retrieved in the referential registry to execute request for renewal of information to the matched resource. A offer will be sent if there are no problem to apply the renewal information to the resource condition. This renewal information can be detailed compared to the summary. Thus, it is possible to avoid decreasing the number of the applicable resources by registering the extremely variable detailed information such as position status.

The prescribed number of resources are determined and integrated according to the integrated condition in the case that a entry permission message is returned from the resource to the offer within the prescribed time. In this time, the condition is validated according to the priority order of the check sequence. It is no determined that the integrated conditions are met if the related information does not meet the relationship condition with the resource already determined. The dependent relationship which the priority order is low is ignored at the time of the initial calculation, if the priority order exists on the dependent relationship. The check sequence according to low level relationship to the determined resource and the entry information is applied, and the determined resource is limited. This is carried out on every level of the dependent relationship to determine the final resources and entries.

The registration information is returned to the determined resource to generate instance for administrating resources including individual interface information to the system side.

The specification of the structured language can be done as follows in order to manage the event efficiently. The description of control contents of the event plan parts to manage scene become elements to construct the event plan as the structured group. The each element may comprise calling of the API, calling description of the lower element and their calling condition, timing, and applicable information of the API such as the entry or the resource. Furthermore, it may have the lower element and definition information of the resource used in the lower element.

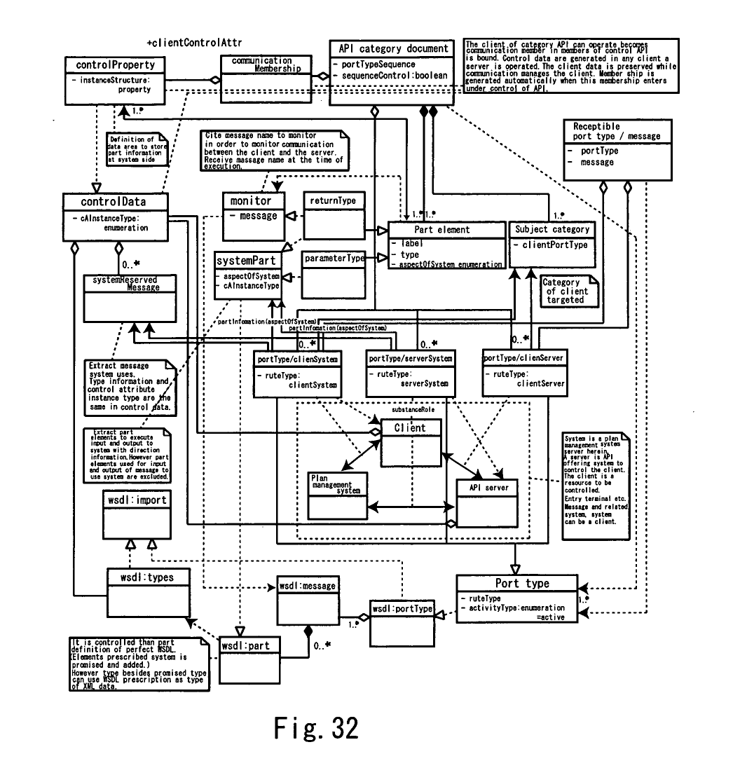

As shown on the FIG. 32, the API and information of the resource and entries which is subject to be applied are categorized by means of communication method with the management apparatus. The category is defined by a group of combination port type of WSDL that a plan management system server, an API management server (a component of the plan management server), and a resource, a management apparatus (a client in the drawing) can use. The category information of the API comprises category information of the applicable resource and entries or direct port type message information, and the port type message information are added to contact with the plan management server. In addition, part information to be managed by the plan may be extracted and gone down the list.

The process and conditions for calling at the time of calling elements of the calling description of the lower elements or API describe according to the control structure of the event plan part. The related application may be used in order to examine the necessary quantity of the resource.

In the case that WSDL is used as the category definition, binding information is set to meet the port type information of item having manifest information of the document on every instance at the time of manifest.

It is possible to describe the event part as an element of the structured document by means of installing the analysis apparatus to be able to construe the above specification in the event execution server. Furthermore, it is possible to extract and apply necessary elements for definition of each event part efficiently and surely at the time of manifest.
(B) Use of Log

It is possible to upload experience of the event of the entries on the internet easily by describing the event execution object as the structured document and to utilize it to the other utilities. A owner exists in the object which exists in the session or the object to be generated. The log information on every execution can be acquired to attach the context information of the session as a tag to data shot by the entry terminal 2 as reference data.

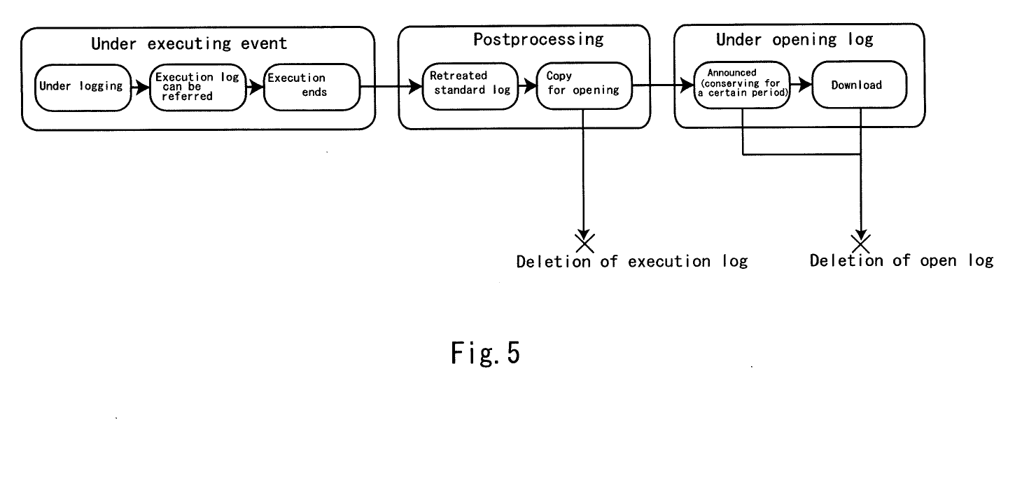

As shown on the FIG. 5, the log changes the status. The log can refer even though the event is executed. For example, the log of previous scene can refer from the following scene when the scene changes over. The basic structure such as an event, a scenario, a scene, a cut is tagged to be kept for ever during postprocessing after the event ends. The execution log logged in at the time of executing this event is deleted after copy before opening. Furthermore, the opening log made the collected log convert to openable status is deleted after keeping for a certain period, and this keeping period can be set by the owner.

Each owner can decide on how to process the attached and output log.

Concretely, the log is used by key reference of entry acquisition data that the entry is corresponded to management object of the event plan managed, title and retaliated information of the management object provided by the sponsor, message information transmitted, and relationship between reference data such as data shot by the sponsor and the like and the management object. The management object log corresponds to record that the entry participated the event by means of scene transition record of the entry.

Each entry can extract the other entries' information that each entry shared the scene by this, and the other entries' information that each entry shared the event record by analyzing commonality of the record. Furthermore, they can extract shared scene information from tag information embedded in the other entries' open log information of the event already opened on network.

The scene shared information extracted be the above process and the reference data related to the scene information are used by the related information of the scene information and structured information. The scene information is converted to streaming transmission provision information such as html data or smil and the like by means of conversion function between the structured documents, and the scene shared information is used, and the event log data on the above object or the electro card are referred mutually and link is executed.

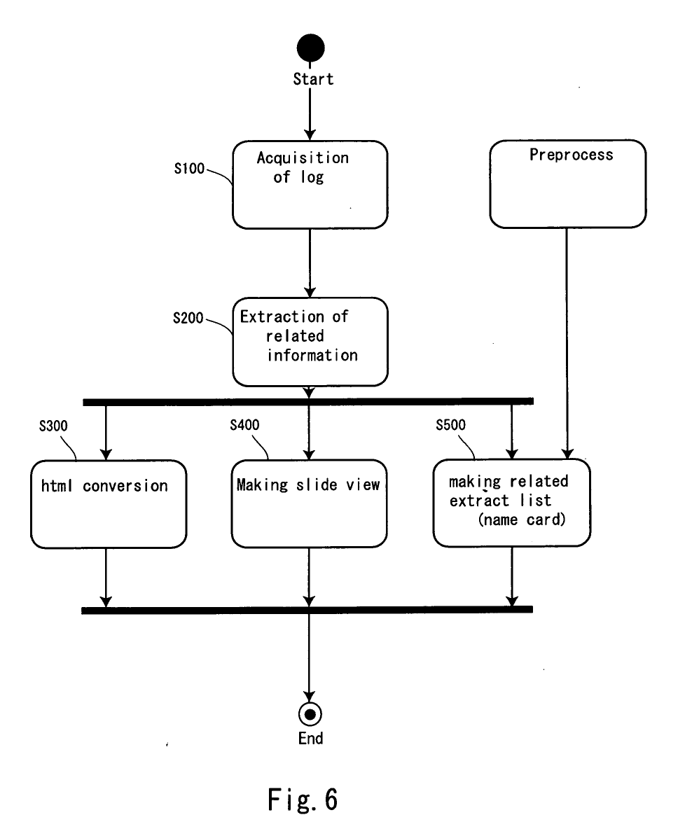

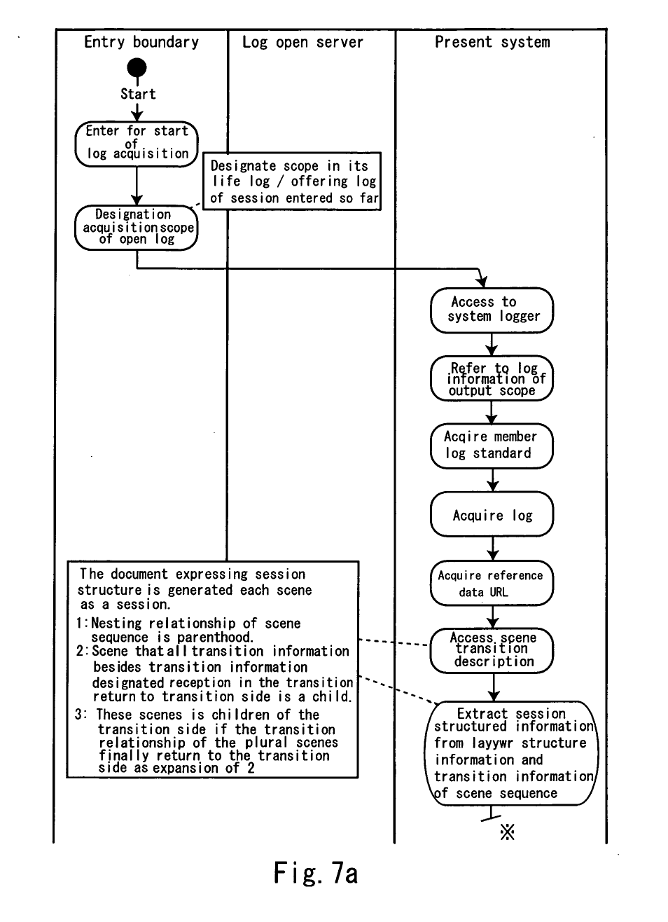

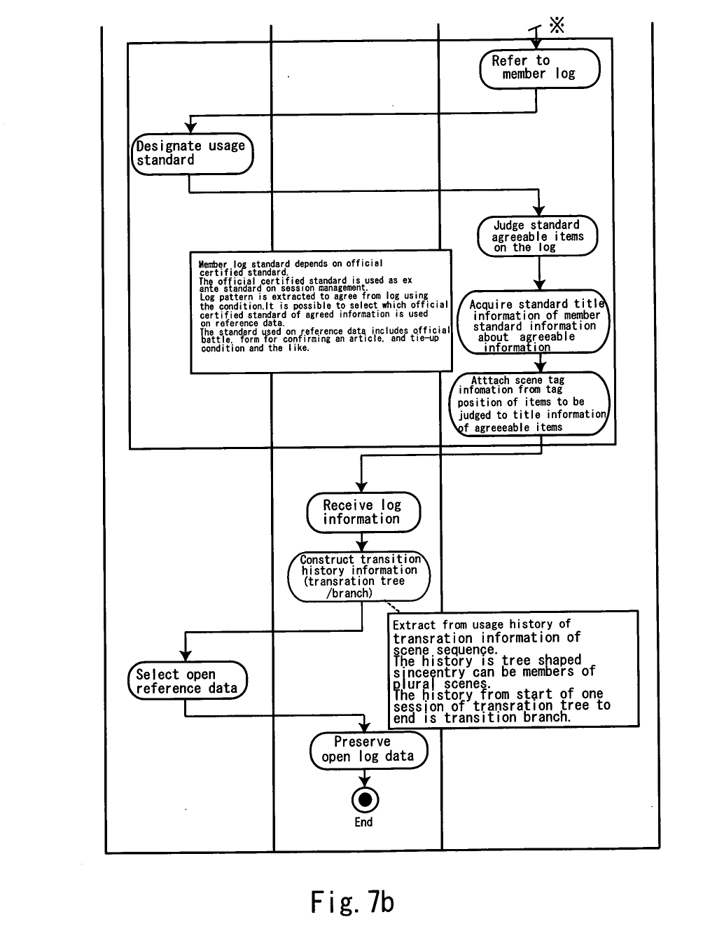

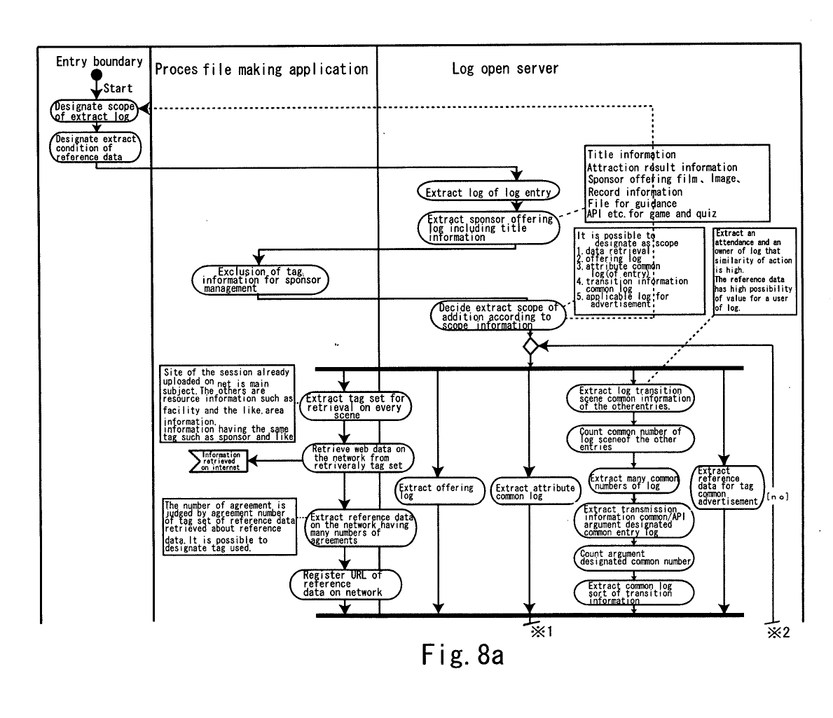

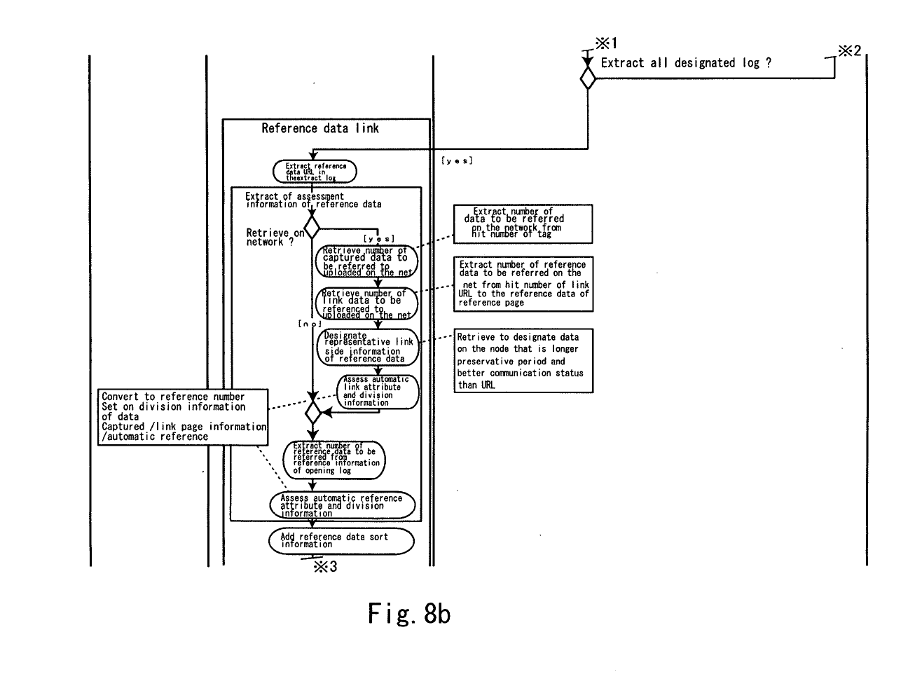

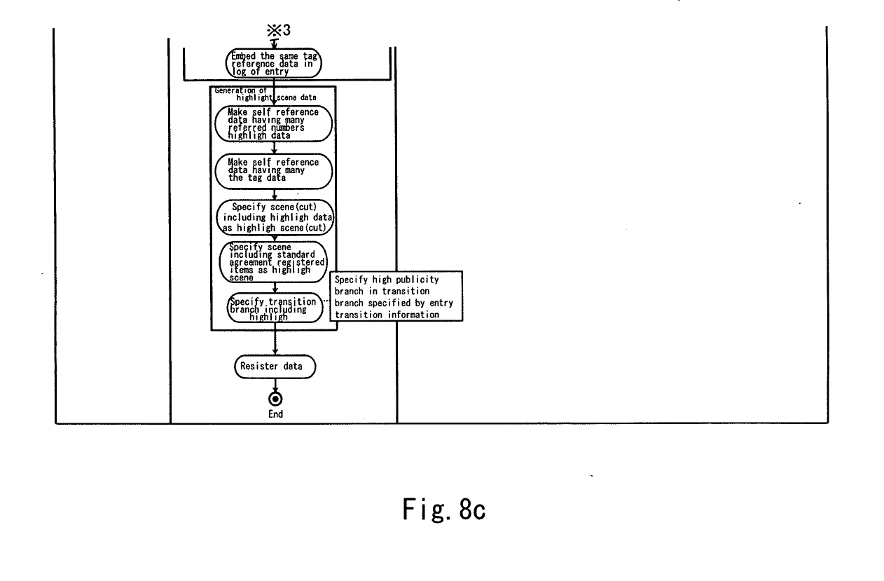

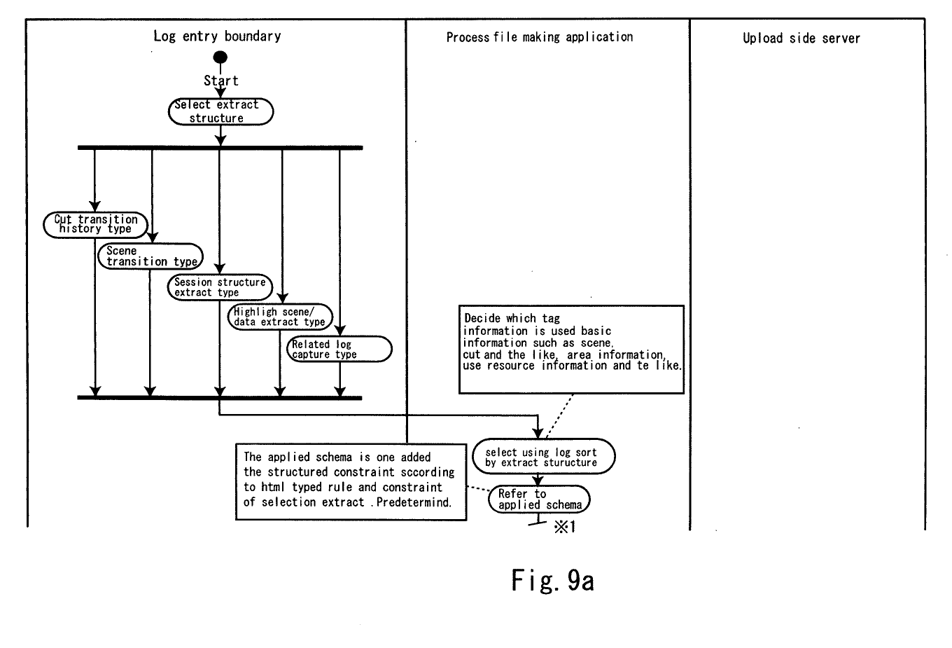

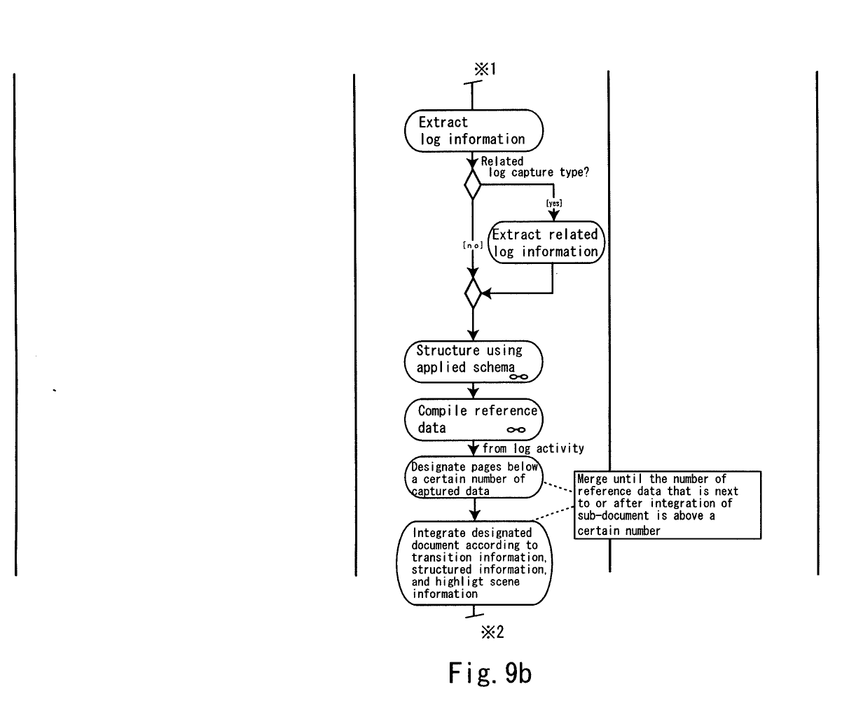

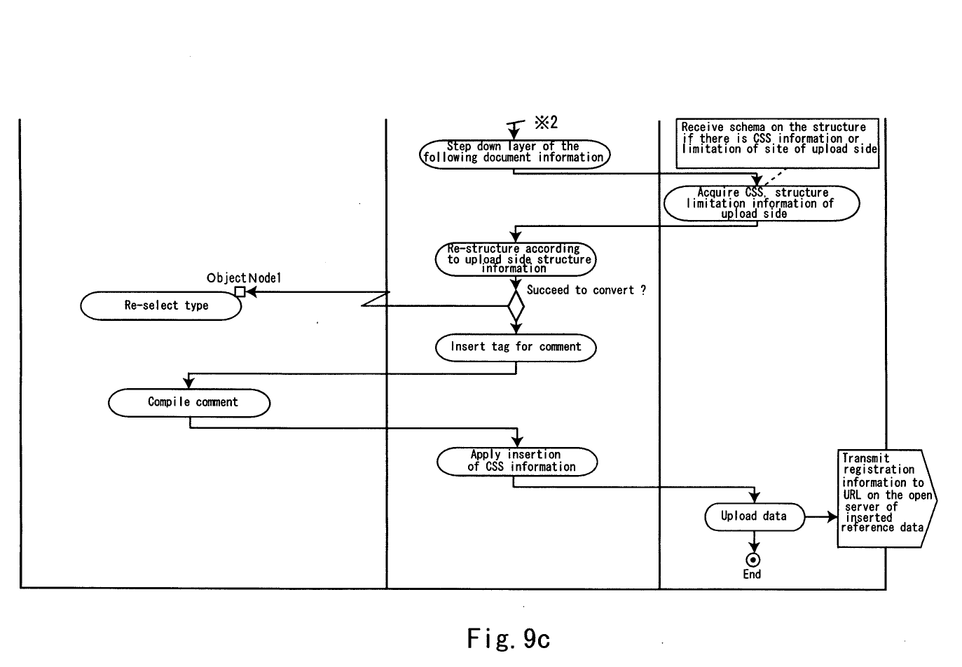

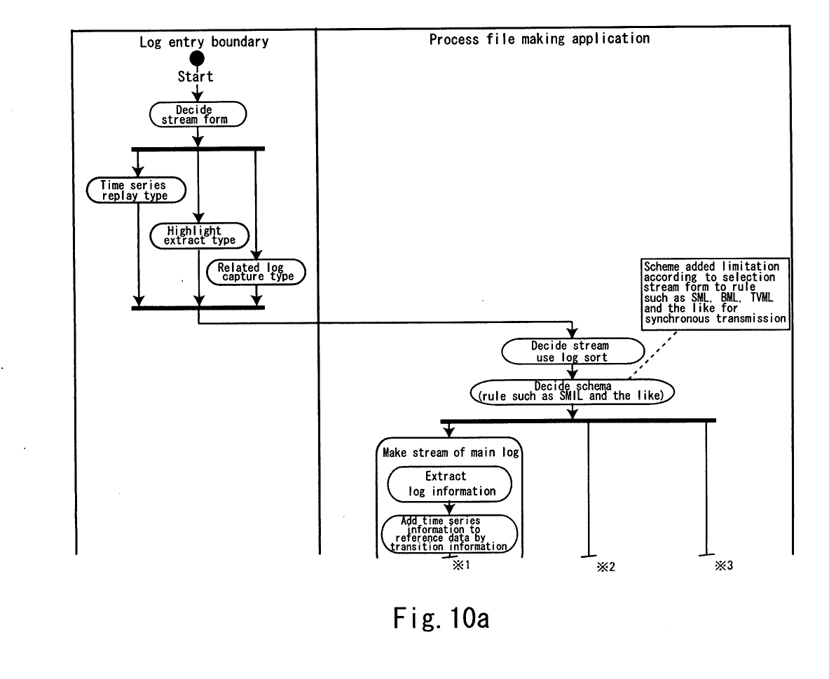

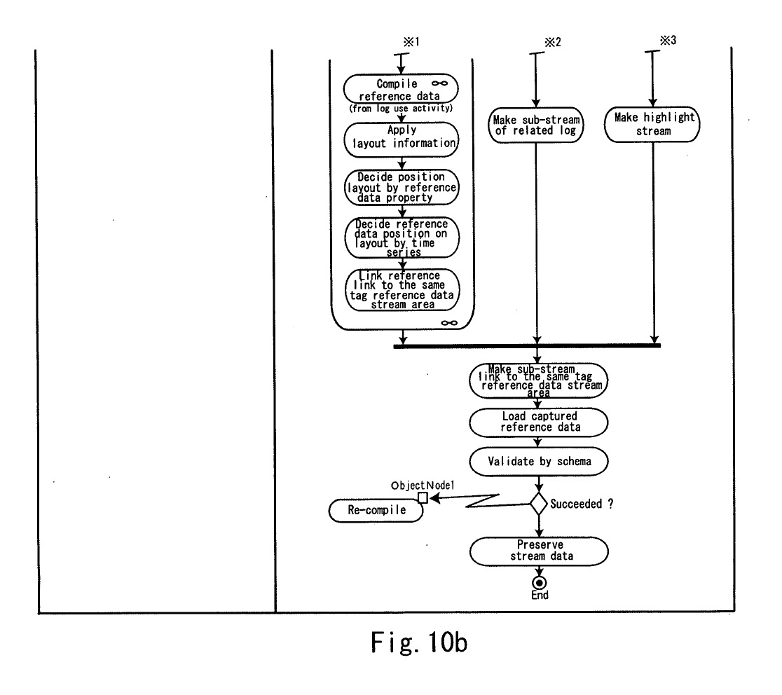

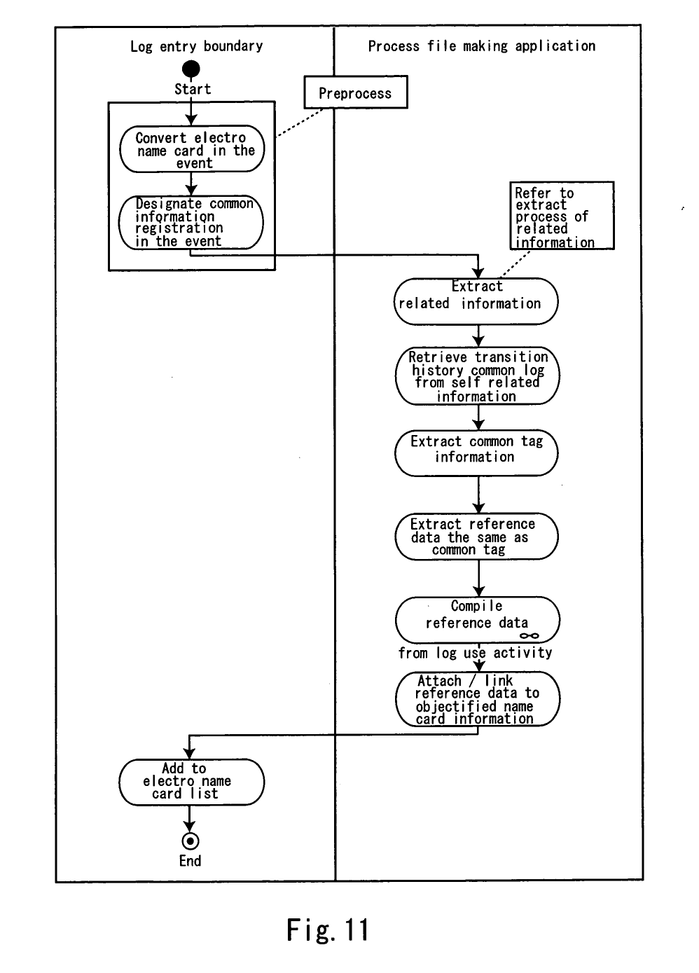

As the FIG. 6 and the FIGS. 7a, 7b˜11, the above processes are executed via log acquisition (S100), extraction of the related information (S200), and html conversion process (S300) or slide view process (streaming of data) (S400) or execution process of the related list (attached card information) (S500), and the predetermined preprocessing is executed before execution process of the related list. Thus, the entry acquisition data can be uploaded on their blog and the like in the easy available form and also mutual reference can be done easily.
(C) Arrangement of the Event Entry

There are two ways that are registration at the time of manifest and entry during event execution to introduce the entry to the event. In the case of using the event as peripheral service of web site, the site receives the entry information to register the entry to meet with manifest condition. The entry was decided at the time of manifest to be administered as a member at the time of session execution.

The session during the execution is attached a flame controlling the entry's entry to the session during execution as an index, and the entry can participate in the event if entry process is executed. The entry in the middle of the session is one from local entry.
(D) Engine at the Time of the Session

We will describe an engine at the time of the session. This description corresponds to an engine for executing the session and the related function part which covers from a layer for supporting the event management application to layers below it at the layer structure.

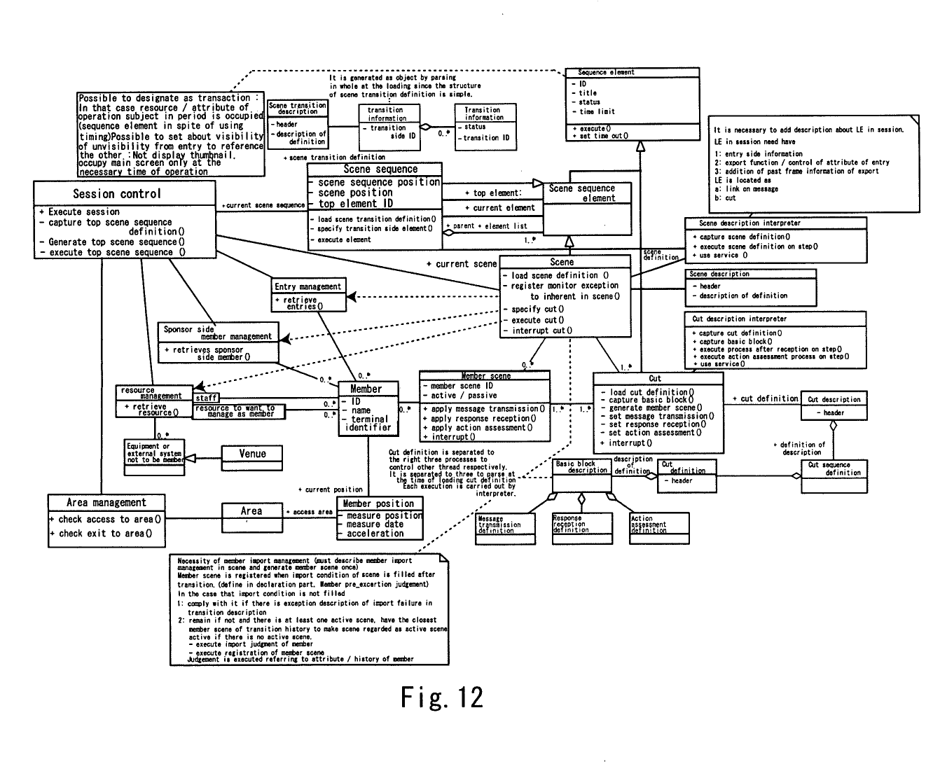

The FIG. 12 shows overall structure for control. The session is shown on multilayer structure of a cut, a scene, and a scene sequence, the transition relationship between scenes is held as transition information in the scene sequence. The management of the entry, the resource, and the member of the sponsor side is controlled as a scene member by the transition side.

The event plan is one that the description such as the scene or the sequence is registered on the database. They can use as a part of the event plan by merging the document to describe the scene transition description, and the resource use condition intensively, since they are constructed as structured documents. The sequence and the scene are executed at the multilayer structure in order to realize this function as shown on the FIG. 12.

Besides, the read was executed on every sequence as describing in the session control. The member scene is controlled to be generated in the member properly corresponding to the control process. The cut is described by repeating the message transmission, the reception of the response, and basic block of action assessment. The process was executed liaising with the service function in the case of executing further high level process, though the FIG. 12 doesn't show it.

The session member can be controlled as a member at the same time as the plural scenes (or session). In this case, how to deal the active or passive control of the scene management window on the control screen of the terminal and double-sided structure, and which scene can control the member status or the attribute have to be decided.
(E) Control of the Member Scene

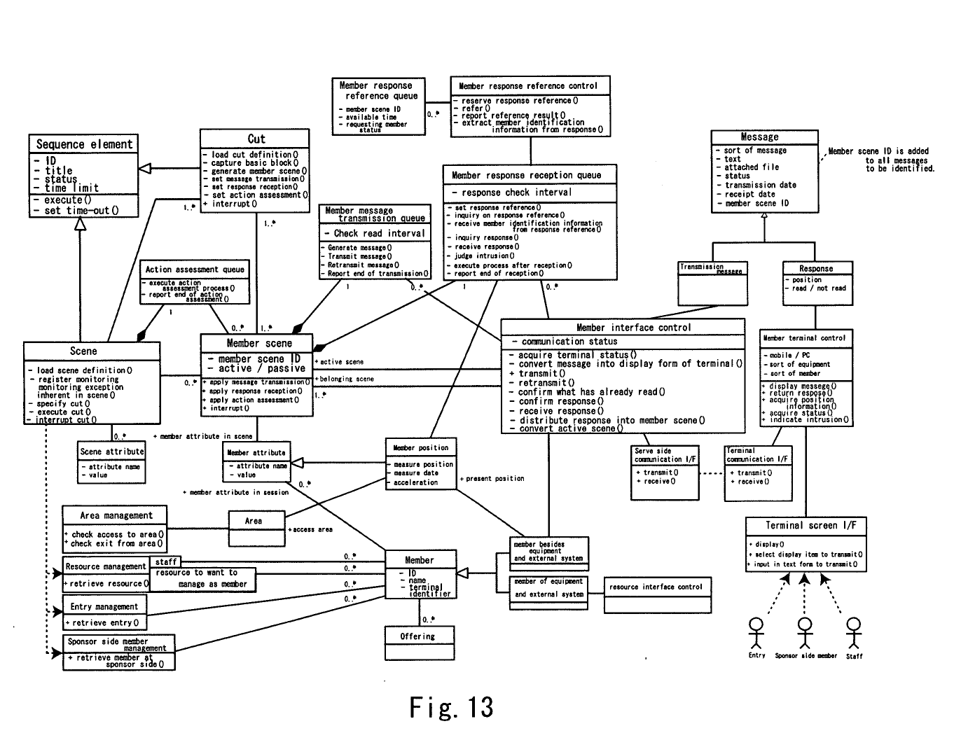

The FIG. 13 shows control of the member scene. The member scene is interface control thread of the member to be generated and processed corresponding to timing of execution of the cut in each member. The transmission and response of the basic block are processed according to interpreter description, and it affects the scene status through the action assessment.

In the FIG. 13, queues are arranged as each control mechanism. The member attribute has each layer of the scene or the scene sequence (session (global)), import (global) level of life control. The entry possesses the import attribute and the sponsor side possesses the attribute below the sequence. However, it can be member attribute described status in the entry's log if the sponsor side designates.
(F) Member Response Control

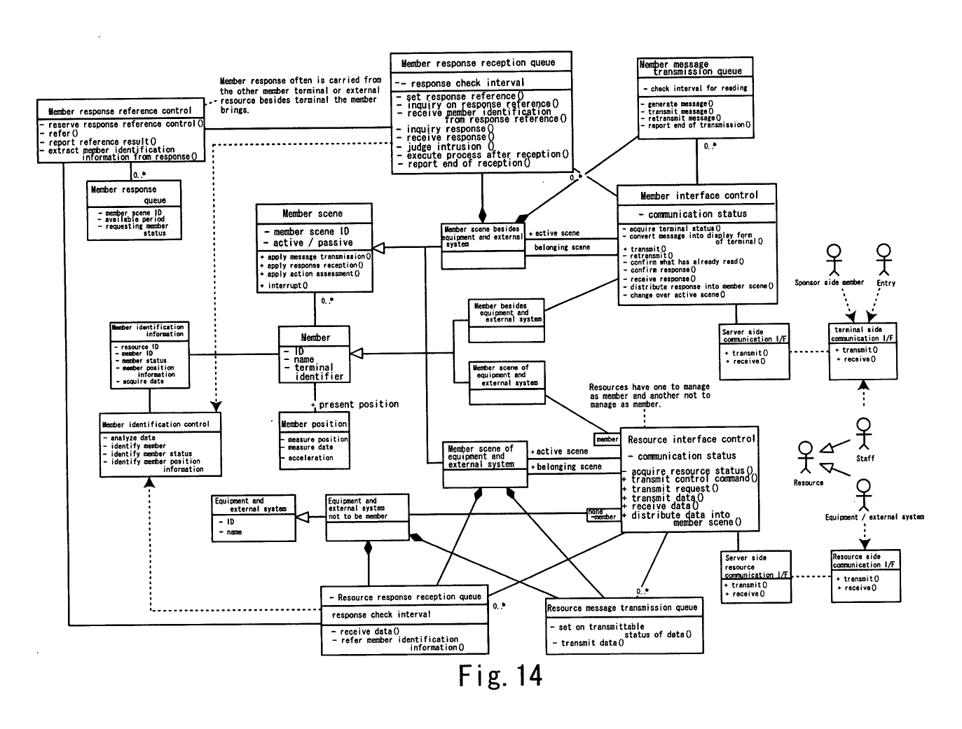

The FIG. 14 shows mechanism about message transmission, response reception, and assessment. There are a member resource with a member scene (a control thread) and a resource without it in the resource. The possibility to be a member exists in the resource that has possibility to be controlled continually by calling a cut such as a display or DMX and the like. The member interface control is applied to the case to execute management of the entry and the staff of the sponsor side by using the terminal.

The entry interface control is the same in spite of the sort of the terminal, and it is controlled at the time of making the message content. The entry terminal includes both of PC and mobile terminal. The context information of the terminal such as the present position is divided into the member position and member class. The member response is acquired via not only the member terminal but also member identification control from LI (Local Interface) information of the other terminals, LI information of the resource, and input information. Besides, though one of the present embodiments describes the form consisting of all three elements of block, it can be done by the only transmission or the only response.
(G) Message Construction

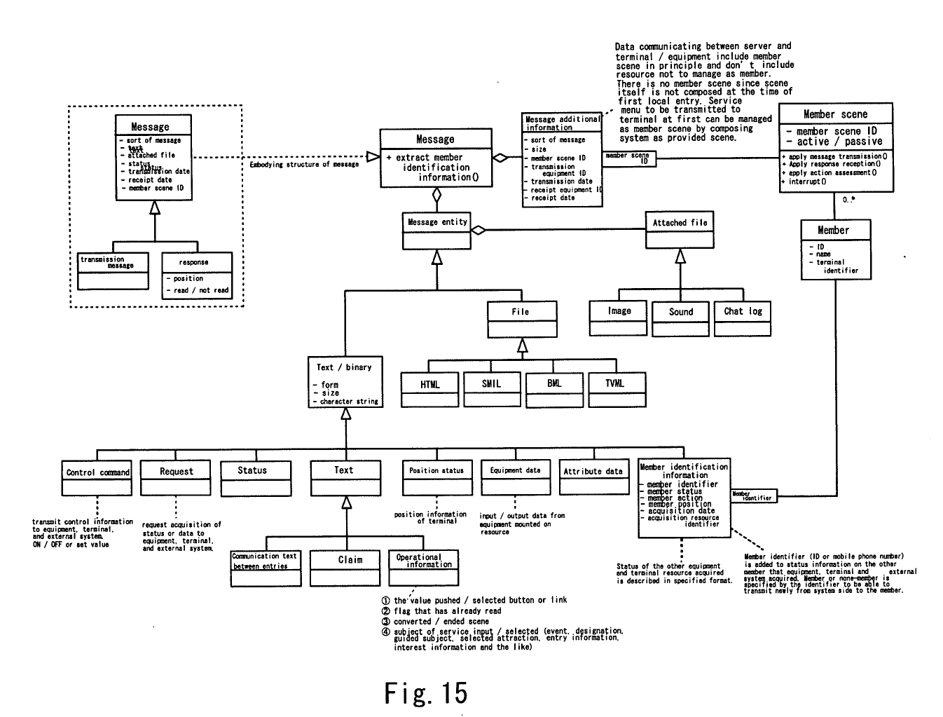

The FIG. 15 shows data dealing as messages. Though the main form of the presumed transmission massage is HTML form, the streaming transmission form such as SMIL and the like or the dependent form on the terminal interface can be taken. The response includes two sorts that are entry to the terminal corresponding to the transmission content and communication with the other terminals using LI, and the context information that the terminal application automatically acquires and the control information are added to them.

The other terminals may include the LI communication with the staff's mobile terminal and the positioning check system such as terminals at the venue or gate and the like. The present system treats contact between the mobile terminals as system certification of human contact on each entry. The message addition information is added to information to be treated as a message to be identified. The identification information of the other member is added to the response message. This information is treated as the other members' response at the time of response control.
(H) Liaison with Service Function

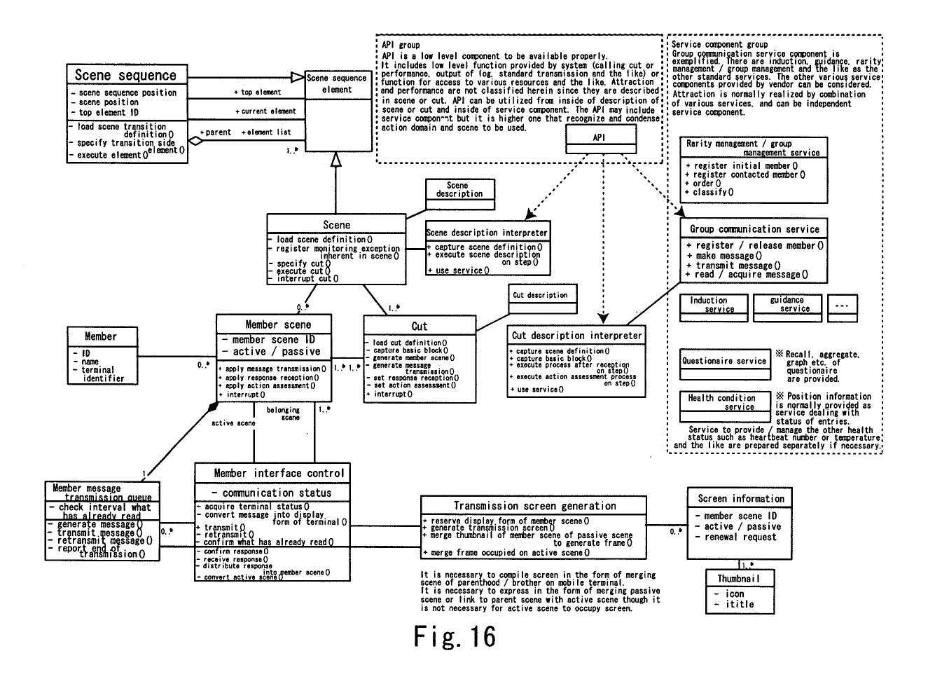

The FIG. 16 shows liaison with service function. The service component has the case that functions as a scene and that functions as a cut. The interface needs to be mounted as the cut in the case of combining with basic messaging block. The service component has the case to use normal interface and the case to start independently to use the terminal application. The screen control in that case depends on the equipment.

Besides, though the FIG. 16 doesn't show exchange of information between the service component and normal scene, it is possible to execute by importing the (virtual) resource (in the server) having function that only holds the attribute information as a member, or by holding on the entry's (session global) attribute.
(I) Logging at the Time of Execution

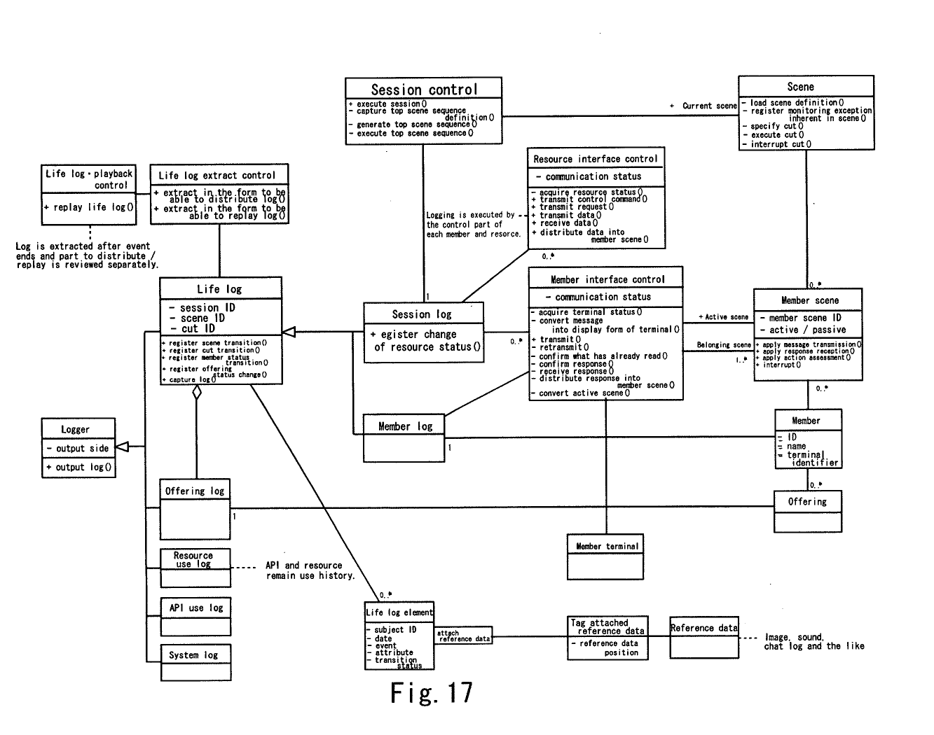

The FIG. 17 shows logging at the time of execution. The log records transition of status information of session and tags the status information on data registered in the entry's terminal, the staff terminal, and the equipment for shooting the resource. A person to be able to use log according to property in the session is decided.
(J) Exception Control

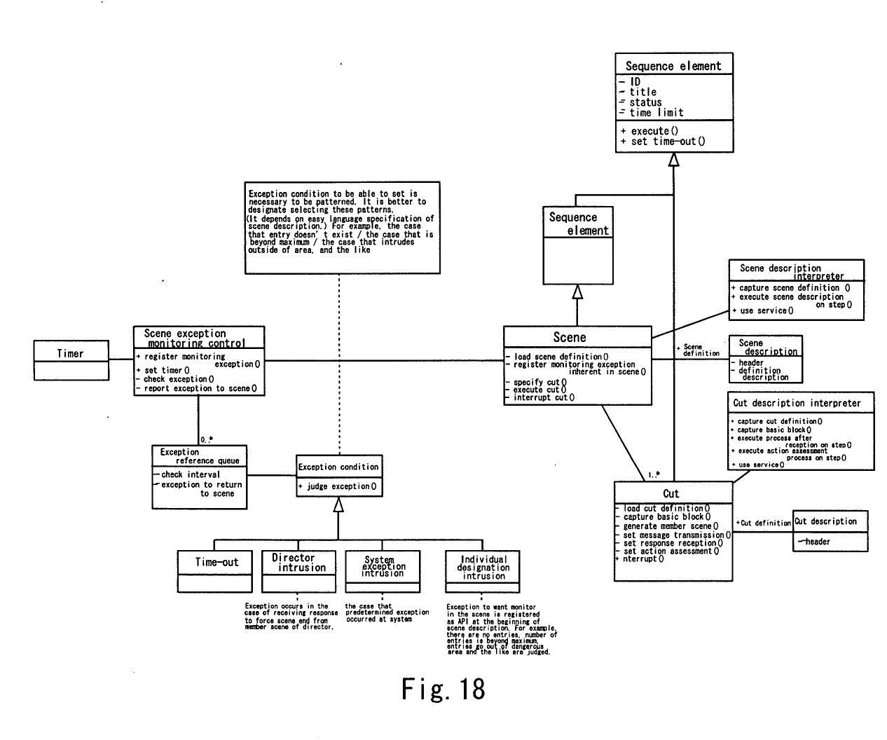

The FIG. 18 shows exception monitoring control of the scene. The occurrence of exception of the scene is monitored by the exception monitoring control. The process after the exception occurred are executed by calling the process scene. The process description is executed in the form of overriding normal treatment scene of system.

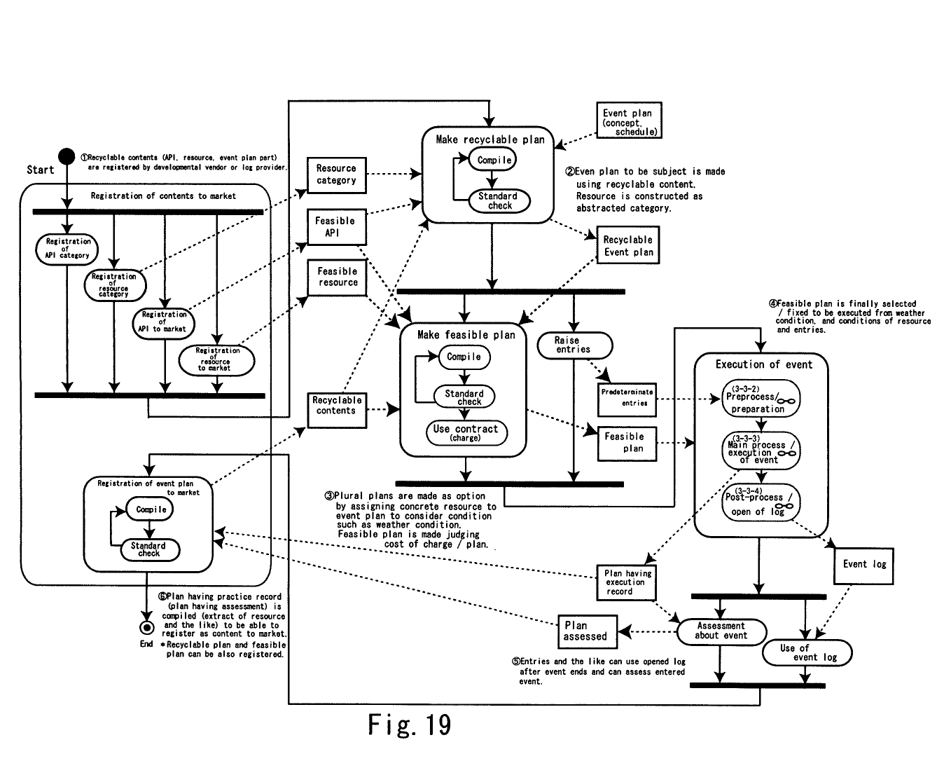

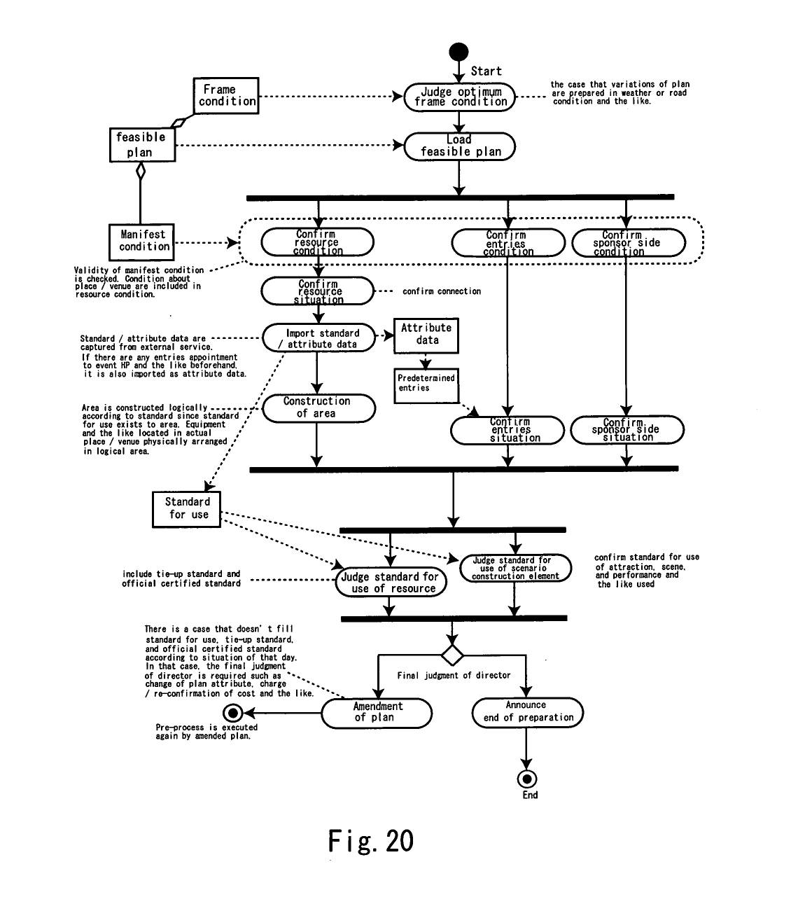

Next, we will describe overall flow of the event management system according to the one of the present embodiments with reference to the FIGS. 19 to 23.

As shown on the FIG. 19, when the contents are registered to the market, these contents are used to make recyclable plan. The recyclable plan consists of manifest conditions such as category description of resource, condition for entry and the like, and scenario. Next, the feasible plan is made by applying actual available resources and context information to the manifest conditions.

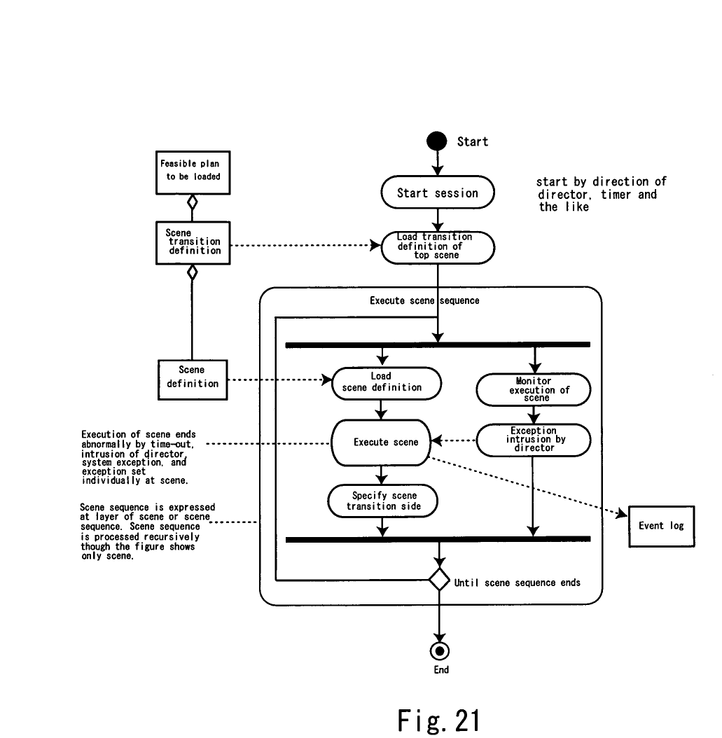

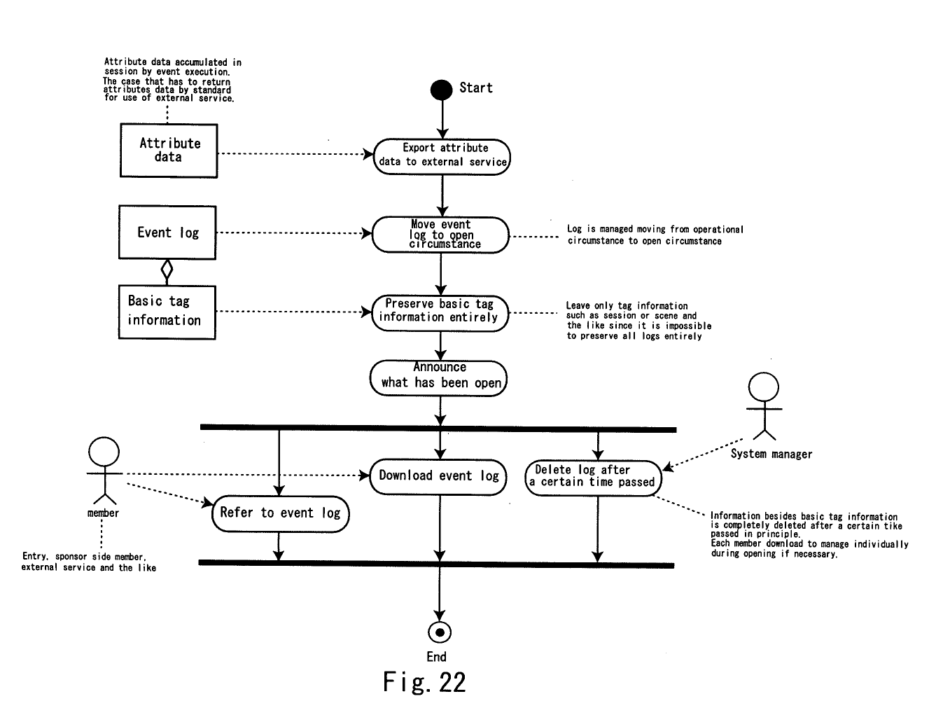

Preprocessing such as check of the resources and entries is executed, when the event is executed as shown on the FIG. 21. The main process is executed when the correction of the plan complete as shown on the FIG. 21. The event execution reflective value for necessary attribute data of synchronous process is exported to generate the event log to use the log when the execution of the session complete as shown on the FIG. 22. Then, the abstraction of the manifest is executed to register the plan in the market.

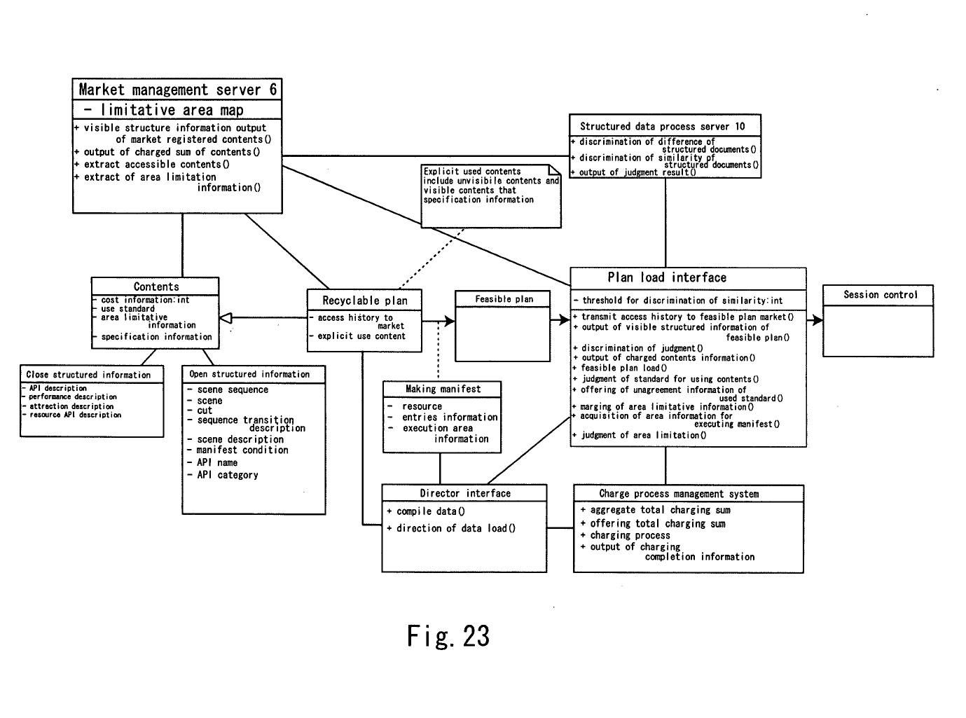

In addition, the check process of copyright is executed by logic model shown on the FIG. 23. The feature of the present system is to register the event plan registered in the market as assembly of scene management object (a sequence, a scene, a cut) having members and API group located at inside. It is possible to treat the total as the structured documents by existing layer relationship and transition relationship between the scene management objects and to use operational application such as XML and the like by means of easy operation.

The copyright process such as charge process or transmission for requesting permission of use and the like is executed when the master copy of the event plan is confirmed by the copyright check.

Furthermore, the feature of the present system is that the entry to the market can select any one of the both contents of the market divided visibility and unvisibility. The unvisible content is protected by the copyright strictly, but the convenience is relatively low. The visible content is protected at a certain level and the convenience is higher since it is easier to alter. It is possible to refer access record from the market at the time of loading the event plan to chase accessibility on the market. The construction is compared and is charged about the visible information.

In one of the embodiments, the visible information consists of structured plan information the entry opens and contents of messages, API calling information, and the unvisible information consists of structured plan information the entry doesn't open and contents of messages, API calling information, binary data and the other program information.

Concretely, the structured data process server 10 connected to the market management server 6 comprises the same function as the structured document process component such as XML pass and the like and executes judgment of difference and similarity to set tree structure of the structured documents, transition structure, API sort, market registration name as lexes. If the similarity is above a certain degree, nodes of the same pass is compared and perused, and the text of the message and the argument of the same API are compared, and final judgment of difference and similarity is executed.

Thus, it is possible to judge difference and similarity of management object transition at the time of execution of event of the entry, messages, or expression part to connection subject outside of program, except for inside expression to be able to alter easily such as variable name and title and the like in inside expression of the plan (program).

It is also possible to control execution area of the execution plan based on execution area control information tagged in registration information at the time of this judgment. Thus it is possible to register in the market in the form of attention to the plan executor at the registration.

Next, we will describe features of specification to add process sort information to the scene management node (the event plan part such as a scene, a sequence and the like) to give subject scope of the member scene of the resource and the entry to transition description between nodes in order to enhance efficiency of calling description of API for control of the member scene.

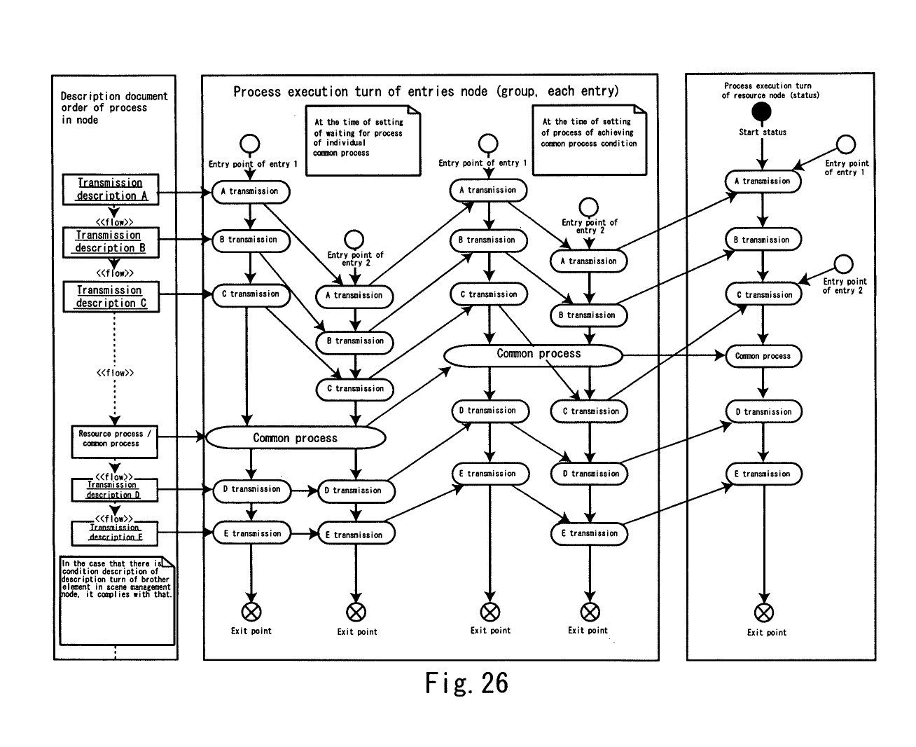

The FIG. 26 shows the difference of sorts of process in the scene of the event management system according to an embodiment of the present invention.

The scene management node description includes process description that executes transmission to each entry terminal and the API application process. Furthermore, it includes resources control of equipments and the like used in the event, and service calling description from the resource to each entry. The description that specifies this member scene management subject has difficulty by features that the event management system has. Namely, the management subject of the event management system is resources of many entries and the service provider side. Especially, in the case that the process description of the resource decides which entry is subject, the decision has to be made whether it is made to each entry once or whether if is made to a certain group once or whether it is made to entry who met to conditions once in the event. The description volume increases when the description specified every subject is included, since these process step description has to hold description of transmission etc. to the other entries and necessary order relationship for the event management. In addition, it is necessary to describe to set relation and execution timing of step especially in many cases since it describes to mainly consider process application to the entries usually. For example, in the case of constructing the event plan to induce a certain group to a store, the process description is described in turn to transmit the service to member entries of the group in order of precedence, When the description is executed to transmit appreciation film by AV terminal at the store finally, the decision has to be made whether it is made each entry when each entry reaches at the store or whether the decision has to be made at a certain timing, for example when final entry reaches at the store. They may describes in turn simply to use the AV equipment in turn to have met the conditions set in the case of executing the process to each entry. However, the description is complicated because both of resources process to each one and overall process exist in the case of executing process to overall group. It is necessary to describe to conform to it and also to describe to acquire and judge information of the other event entries since timing deviates at the time of processing receiving response especially. There is high possibility to needlessly increase description volume of service that needs individual process when all specification of the description are set by this criteria. Furthermore, it is difficult to describe process description of resources moving at the unique timing in the specification describing each entry's transmission in turn from the entries entry, though it is natural to describe according to progress of the resources process for a description person, in the case of the event to mainly execute the resources process such as transmission of music information to the entry's terminal according to the progress of set list of concert and the like, and especially in the case that the event entry timing of the entries can be in the middle of the concert. However, these descriptions are very easy, if the scene management node exists at the timing of the resources process.

The entry transits between these scene management nodes according to the transition information to receive service transmission described in each node. However, in the case that the plural types of scene management nodes exists and the specification is one to issue transition status information to individual member scene, the cases to conflict with the process increase. The group process, the node process, and the resources process node process occur according to the number of transited entries if there is no rule, in the case that the group process or the resources process node transit to the group process or the resources process node, and that the first process of the transition side is transition status information. There is also similar difficulty in the case of use the transition status at timing (trigger) information in the node. In order to avoid this problem, the subject having possibility to generate a member scene in the transition status information, namely collective scope information which entries or sometimes resources are subject is given. Thus, it is not necessary to bring the description of complicated process rule to transition process mechanism management compared to the case to correspond by means of giving function such as collective process of coincidental transition status process by conditions of transition information of the same node to another node. In addition, it is possible to avoid conflict that the transition process mechanism or another node interprets the nature of the transition status to be defined at the original node process.

In order to consider the above request, the system has function comprising more than three sorts of scene management node process function to give scope information in response to process rule of the transition side to transition information between scenes. Thus, it control legitimately the transition process between the scene management nodes having plural process sorts. The process subject of one of process sorts of three management nodes is resources related to individual entry. The collective process rule doesn't exist, and the process description corresponds to document order to be executed in turn from node transition point of the entry. The subject of occurred transition information is at least individual entry. The second process subjects are resources related to group of the entry, and the collective process rule exists. It has function to collect action assessment of each entry in the node to execute resources process according to the timing information. The process description is processed in turn from node transition point of anyone of the entry group. The process is executed the action assessment referring to whether all entries of the attribute group that corresponds to setting of user group though it depends on the described condition, if setting of user group depending on attribute of the entry management object that is a member of the scene. The occurred transition information is inherent in group, and its scope is each entry in the scene or individual entry. The third process subjects are resources and entries of the scene nodes at the time of process occurrence, and the collective process rule exists. It has function to collect action assessment of each entry in the nodes to execute the resources process or the transmission process according to the timing information. Furthermore, it has specific start status information. The process description is processed according to the document order when it receives the transition status corresponding to the start (entry) status. The entry to apply node by the start status or the other transition status receives raw transmission and process at that point. The occurred transition information is scope of the present entry, or it is inherent in entry group in the nodes and scope of each entry, or subject of individual entry.

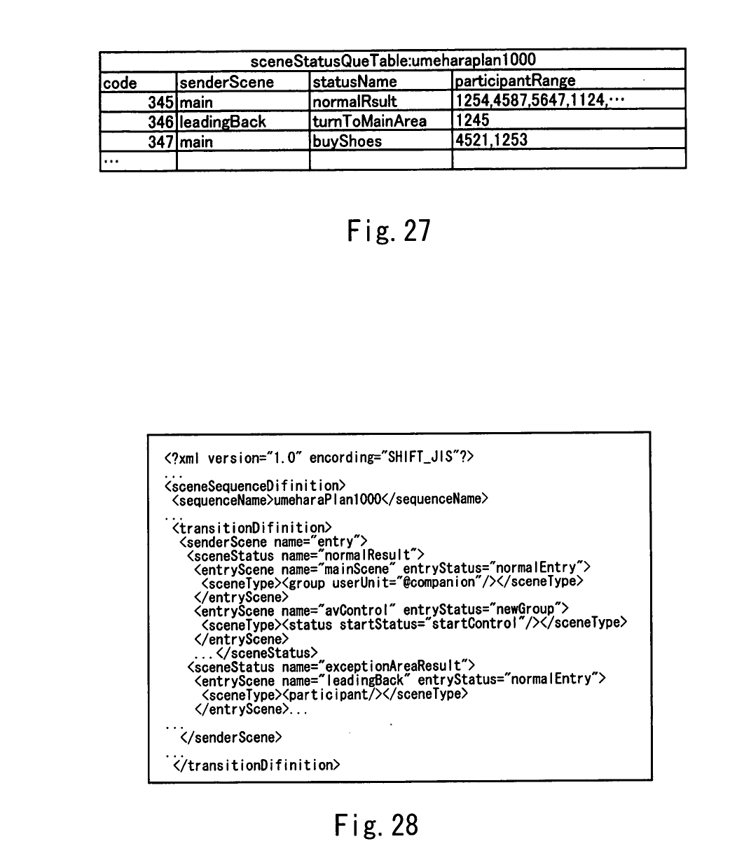

In order to realize the above specification, the system comprises transition information holding part to hold scene status queue table (see the FIG. 27) receiving transition status from the scene object in the transition process function part of the scene sequence process class on the FIG. 17 in the form including the scope information to hold the transition information of every status of sequence description. The transition information interpreted the sequence description is held in the transition information holding part. The transition information may have the scene of status occurrence side, the name of transition status, the scene name of transition side, the scene sort information and the attribute of user group subject entry or start status information, and the entry status name is held. The scene of the transition side needs not to be one. The FIG. 28 shows the example of the transition information at the XML description. The transition process function part can acquire the status information of the scene process part at the transition side, and have function to execute process start of the transition side scene and the entry process of the entry. Furthermore, it can refer to the entry information and acquire group information of the attribute. The attribute group information includes attribute information, instance ID, and instance member (entry) information. In addition, it can retrieve the entry information to acquire scene information belonged at present, and these may be held as a table in the transition process part.

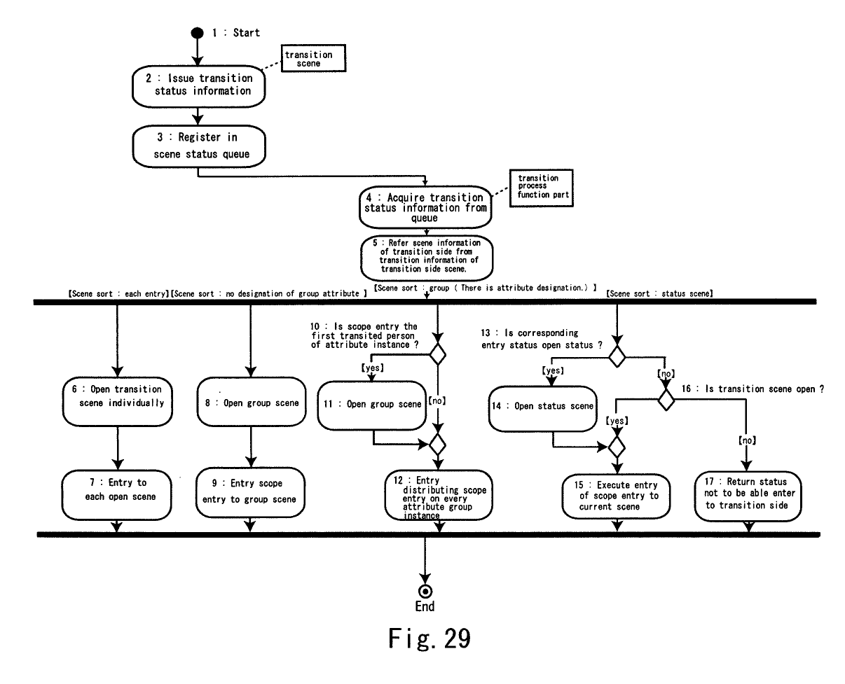

The FIG. 29 is a flowchart showing a scene transition process of an event management system according to an embodiment of the present invention.

When the transition information is issued in the transition side scene, the information is registered in the scene status queue table of the direct above scene sequence. The sequence transition process function part reads the registration information of the table as soon as proximate process completes, and it refers to the registration information of the transition side of the corresponding transition status name of the corresponding transition side scene of the transition information holding part. At this time, the entry status information corresponding to the transition status is returned to another scene, and the decision is made on which process in the scene description is applied to.

1: The system opens scene instance about each entry in the scope of the transition status to start the process in the case that the transition scene is process scene of individual entry.

2: The system executed entry of the entry in the scope of the status as group member in the case that the transition scene is group scene and the attribute group is not designated on the scene. It judges on whether the entry is a first transited person of the attribute group instance or not, if the attribute group is designated. If so, it opens the scene instance on every attribute instance included to execute entry process of each member to the subject scene. If the scene instance has already been opened to the attribute instance, the corresponding attribute instance member is executed entry process to the opened scene. At this time, the process in the raw scene is anteceded.

3: The system judges on whether it is open status in the case that the transition side scene is the status scene. It opens new scene instance in the case of open status to execute entry process of the entry. If it is not the open status, the last open scene instant executes entry process to the entry. If it is not the open status, the last open scene instant does not always execute entry process to the entry, and the other function may be added, for example if the constant of the entry is set in the scene, the scene that redundant personnel is the most executes entry process. Furthermore, in the case that normal transition is executed when any scene instance is not opened, the exception information is returned to the transition side scene and the transition is not executed.

Besides, the following specification can be incorporated in the scene management node description to incorporate function for the realization in order to provide service corresponding to context of the scene on the entry event to the entry.

Request resources: It is possible to describe sort and number of necessary resource for opening the scene process, existence or work in the designated place and time, and important status transition information such as property or open as request resources information in order to prepare securely resources such as necessary equipments or articles at the scene of the event. It is impossible to call the scene if the status information of the request resources described can not be checked by means of input information such as connection, or local interface or sensors and the like. The method according to the Japanese patent application No. 2007-85407 can be used to integrate description information of each scene in all scenario at the time of adaptation.

Interface change over control: It is possible for entries to provide integrated interface of the scene to provide services such as transmission corresponding to scene in the consistent and easy distinctive form. The process definition information at the time of acquisition of the other terminals and context information by local interface and sensors regarding the scene node description, the process definition information of function key displayed on the terminal screen, the following node sort information and further condition process as transmission order control information in the node, and order change information of transmission step of cut in and threaded sub-node and the like are incorporated as interface control information of the scene. These are ones that a maker compiles the service related to the scene easily and that provide in the orderly comprehensive form to entries.

The system expands to be able to define about the process mode identification at the time of acquiring information of local interface and execution of the process of individual transmission process group in the node, though the method to integrate so that a user can understand interface easily is the same as window process in PC. Thus, in the case of integrating interface of the scene, it is necessary for the entry to guarantee devotion of input at the time of receiving the plural scene services, or to use changing over active scene interface in order to execute transmission control. Thus the information that is active or not on every instance at the time of executing the event of the scene management node of the scene and the like (see the FIG. 17) to the entry's status is added. The terminal acquisition information transmitted from the terminal to the member interface control in the FIG. 18 at the time of executing the control discriminates the input to execute the difference control according to active scene at the time of being sent to the member scene.

In the case of acquiring the context information such as the other terminals or place by local interface and the like, the process of the acquisition data such as ID or position information and the like are executed in each node according too the entry's active nature according to the definition information on every scene node that the entry belongs to. In the case that for example the entry belongs to two scenes AB, and the definition is made to execute the process to be member to the same group in the scene A and not to execute in the scene B at the time of local interface contact with the other entries having specific attribute, and in the case that the entry is active at A presently for example according to the definition of the present active scene management node, another entry belongs to the same group.

Individual transmission is executed based on after-mentioned sort information and the like in the active node of the transmission control, and the transmission execution is ignored at the other belonged scene. The change over between these scenes is displayed as caution information to promote change over of the scene at the time of transmission schedule at the other scenes, or it may be in the form of changing over automatically based on acquisition of the context information as described in Japanese paten application No. 2007-285407.

It is possible to construct the scene management node to meet with scene division that the entry senses at the entry event by means of locating analysis apparatus to be able to interpret the above specification, and to make the event plan easily and to enhance effect of the related services.

According to the above event management system of an embodiment of the present invention, the following effect can be obtained.

(1) It is possible for any level of sponsor to execute the event effectively by carrying out the event management according to form stocked in the market.

(2) It is possible to stock plan asset efficiently by constructing in the form to match the market regarding to the event with technical level and aptitude of registrant.

(3) It is possible to use the execution record on the internet efficiently by system control of the event management. In addition, it is possible to execute the event in the form of referring to data on the internet.

(4) It is possible to open the event in the various form since it is possible to open the event easily, remotely, at the same time.

(5) It is possible to incorporate various function from local entry limited to connection to the site to adjacent stores, or to the guidance advertisement at the store.

(6) It is possible for the sponsor to select the event efficiently since it is possible to refer progress structure of the event explicitly to the conventional event management used the web site and the client database.

(7) It is possible to execute event management easily and securely since the control mechanism is installed normally in the case of realizing high level management such as timing control, contact between entries and the like.

What is claimed is:

1. An event management system for executing the management of an event, comprising:
an event plan making means for constructing an event plan or an event plan component by a structured document and making a feasible event plan by means of combination thereof; and
an event execution means for executing transmission of a message and reception of a response between entry terminals used by event entries to control progress of the event.

2. The event management system according to claim 1, further comprising:
a log open means for acquiring log information of the entry while the event execution means control the progress of the event and making reference to information provided by a organizer or the log information of the entry mutually based on the document of the common event plan component executing the management at the time of event execution by the entry or node identification information.

3. The event management system according to claim 1, further comprising:
a means for recording the event plan and the event plan component in a database to be able to open and refer, and a step for discriminating the difference of the structured document between the event plan referred by a event plan maker and the event plan made by the event plan making means to execute copyright process to the entries if there is similarity between them.

4. An event management method for executing the management regarding the event comprising:
constructing the event plan or an event plan component by a structured document and making an feasible event plan by means of combination thereof; and
executing transmission of a message and reception of a response between entry terminals used by event entries to control progress of the event.

5. The event management method according to claim 4, further comprising:
acquiring log information of the entry while the event execution means control the progress of the event and making reference to information provided by a organizer or the log information of the entry mutually based on the document of the common event plan component executing the management at the time of event execution by the entry or node identification information.

6. The event management method according to claim 4, further comprising:
recording the event plan and the event plan component in a database to be able to open and refer, and a step for discriminating the difference of the structured document between the event plan referred by a event plan maker and the event plan made by the event plan making means to execute copyright process to the entries if there is similarity between them.

7. A computer readable medium having embodied thereon a computer program for processing by a computer to perform event management, the computer program comprising:
an event plan making code segment for constructing the event plan or an event plan component by a structured document and making an feasible event plan by means of combination thereof; and
an event execution code segment for executing transmission of a message and reception of a response between entry terminals used by event entries to control progress of the event.

8. The computer-readable event management program according to claim 7, further comprising:
a log open code segment for acquiring log information of the entry while the event execution means control the progress of the event and making reference to information provided by a organizer or the log information of the entry mutually based on the document of the common event plan component executing the management at the time of event execution by the entry or node identification information.

9. The computer-readable event management program according to claim 8, further comprising:
a recording code segment for recording the event plan and the event plan component in a database to be able to open and refer, and a step for discriminating the difference of the structured document between the event plan referred by a event plan maker and the event plan made by the event plan making means to execute copyright process to the entries if there is similarity between them.
